(19) United States
(12) Patent Application Publication
(10) Pub. No.: US 2024/0056861 A1
(43) Pub. Date: Feb. 15, 2024

(54) METHOD PERFORMED BY BASE STATION, BASE STATION AND COMPUTER READABLE STORAGE MEDIUM

(71) Applicant: Samsung Electronics Co., Ltd., Suwon-si (KR)

(72) Inventors: Weili CUI, Beijing (CN); Meifang JING, Beijing (CN); Ying LI, Beijing (CN); Hui CHEN, Beijing (CN); Jiajia WANG, Beijing (CN); Fang XIE, Beijing (CN)

(21) Appl. No.: 18/329,840

(22) Filed: Jun. 6, 2023

Related U.S. Application Data
(63) Continuation of application No. PCT/KR2023/006520, filed on May 14, 2023.

(30) Foreign Application Priority Data
Aug. 10, 2022 (CN) 202210956638.7

(51) Int. Cl. H04W 24/10; H04W 16/28

(52) U.S. Cl. CPC H04W 24/10; H04W 16/28

(57) ABSTRACT

Embodiments of the disclosure provide a method performed by a base station, a base station and a computer readable storage medium. The method includes: instructing a user equipment (UE) to perform a beam measurement at a first beam level; determining, based on at least one of information on transmission capacity, mobility information and traffic information of the UE, whether to instruct the UE to perform a beam measurement at a second beam level; and receiving beam measurement results of the UE and performing beam scheduling, and wherein, a scheduled beam includes a beam at the first beam level or a beam at the second beam level; and serving cells of the base station are covered by each of the beam levels, and beams at different beam levels have different attributes. Part of the the implementation process of the scheme can be achieved by artificial intelligence. The disclosure saves measurement overhead while ensuring communication quality, and achieves the effects of improving cell throughput and user experience.

### CROSS-REFERENCE TO RELATED APPLICATIONS

This application is a continuation of International Application No. PCT/KR2023/006520 designating the United States, filed on May 14, 2023, in the Korean Intellectual Property Receiving Office and claiming priority to Chinese Patent Application No. 202210956638.7, filed on Aug. 10, 2022, in the Chinese Patent Office, the disclosures of which are incorporated by reference herein in their entireties.

### BACKGROUND

### Field

The disclosure relates to the field of wireless communication technology, and for example, to a method performed by a base station, a base station, and a computer readable storage medium.

### Description of Related Art

In the 5th generation mobile communication technology (5G), the millimeter-wave frequency band can support wireless transmissions with high data rate and satisfy transmission requirements of a large number of 5G devices, but is very sensitive to rapid channel change and may generate serious path loss. Therefore, in millimeter wave system, user communication is based on beamforming, which can concentrate the signal energy in the desired transmission direction, obtain obvious beam gain, and compensate the path loss. Beamforming technology requires the use of beam management processes, including beam pattern design, beam measurement and reporting, and beam scheduling.

The current beam management scheme cannot maintain the communication quality while saving the measurement overhead of users, so it is necessary to propose a new beam management method.

The above information is presented as background information only to assist with an understanding of the disclosure. No determination has been made, and no assertion is made, as to whether any of the above might be applicable as prior art with regard to the disclosure.

### SUMMARY

Embodiments of the disclosure address at least one of the above mentioned defects, and various embodiments include the following:

Embodiments of the disclosure provide a method performed by a base station, including:
instructing a user equipment (UE) to perform a beam measurement at a first beam level;
determining, based on at least one of information on transmission capacity, mobility information and traffic information of the UE, whether to instruct the UE to perform a beam measurement at a second beam level; and
receiving beam measurement results of the UE and performing beam scheduling, and
wherein, a scheduled beam includes a beam at the first beam level or a beam at the second beam level; serving cells of the base station are covered by each of the beam levels, and beams at different beam levels have different attributes.

In an example embodiment, if the scheduled beam is the beam at the first beam level, the UE served by the scheduled beam comprises the UE performing measurement on the beam at the second beam level.

In an example embodiment, if the scheduled beam is the beam at the first beam level, based on the serving beam for the UE being the beam at the second beam level, the method further includes:
determining, based on remaining resources of the scheduled beam and/or the information on transmission capacity of the UE, whether to adjust the serving beam for the UE to the scheduled beam.

In an example embodiment,
the attribute of the beam comprises the number of beams and/or a beam width; and/or
beams at different beam levels have different widths, and the beam width of the first beam level is greater than the beam width of the second beam level; and/or
the base station corresponds to at least one second beam level.

In an example embodiment, the information on transmission capacity includes an average synchronization signal reference signal received power (SS-RSRP); and/or
the mobility information comprises a beam change frequency (BCF).

In an example embodiment, determining, based on at least one of information on transmission capacity, mobility information and traffic information of the UE, whether to instruct the UE to perform a beam measurement at a second beam level, includes:
determining the beam level corresponding to the UE based on at least one of the information on transmission capacity, the mobility information and the traffic information of the UE; and
instructing the UE to perform the beam measurement at the second beam level based on the determined beam level corresponding to the UE is the second beam level.

In an example embodiment, based on the UE being currently in the first beam level, determining the beam level corresponding to the UE, includes:
determining, based on the information on transmission capacity and/or the mobility information of the UE, the adjusted beam level corresponding to the UE; and
determining, based on the traffic of the UE to be transmitted, whether to adjust the beam level for the UE to the adjusted beam level.

In an example embodiment, determining whether to adjust the beam level for the UE to the adjusted beam level, includes:
based on the traffic of the UE to be transmitted not being zero, adjusting the beam level for the UE to the adjusted beam level; and
based on the traffic of the UE to be transmitted being zero, keeping the beam level for the UE constant at the first beam level and saving the adjusted beam level.

In an example embodiment, based on the UE being currently in the second beam level, determining the beam level corresponding to the UE, includes:
determining, based on at least one of the traffic of the UE to be transmitted within a specified number of consecutive slots, the information on transmission capacity and the mobility information of the UE, whether to adjust the beam level for the UE to the first beam level.

In an example embodiment, determining whether to adjust the beam level for the UE to the first beam level, includes:
based on the traffic of the UE to be transmitted being zero within a specified number of consecutive slots, adjusting the beam level for the UE to the first beam level and saving the beam level for the UE before the adjustment;
based on the information on transmission capacity of the UE indicating that the transmission capacity of the UE meets a first specified condition, adjusting the beam level for the UE to the first beam level; and
based on the mobility information of the UE indicating that the mobility of the UE meets a second specified condition, adjusting the beam level for the UE to the first beam level.

In an example embodiment, the method further includes:
based on the traffic of the UE changing from zero to non-zero, adjusting the beam level for the UE to the corresponding second beam level; and
wherein, the corresponding second beam level is the last saved beam level.

In an example embodiment, based on the UE currently being in the second beam level, determining the beam level corresponding to the UE, includes:
determining, based on at least one of the information on transmission capacity and the mobility information of the UE, whether to adjust the beam level for the UE to another second beam level.

In an example embodiment, determining whether to adjust the beam level for the UE to other second beam level, includes:
based on the information on transmission capacity of the UE indicating that the transmission capacity of the UE meets a third specified condition and the mobility information of the UE indicating that the mobility of the UE meets a fourth preset condition, adjusting the beam level for the UE to the other second beam level.

In an example embodiment, the method further includes:
obtaining, using a prediction model, a predicted traffic of each beam coverage area of the first beam level, based on a historical traffic of each beam coverage area in the first beam level; and
determining, based on the predicted traffic of each beam coverage area of the first beam level, the attribute of beam at the second beam level respectively corresponding to each beam at the first beam level.

In an example embodiment, the method further includes:
obtaining historical information on transmission capacity of each beam at the first beam level; and
adjusting the predicted traffic of each beam coverage area of the first beam level based on the historical information on transmission capacity of each beam at the first beam level.

In an example embodiment, the attribute of beam includes the number of beams and/or a beam width, the number of beams includes the number of vertical beams and the number of horizontal beams, and the beam width comprises a vertical beam width and a horizontal beam width;
wherein, determining, based on the predicted traffic of each beam coverage area of the first beam level, the attribute of the beam at the second beam level respectively corresponding to each beam at the first beam level, comprising:
obtaining, based on the predicted traffic of each beam coverage area of the first beam level, the number of vertical beams and the number of horizontal beams at the second beam level respectively corresponding to each beam at the first beam level; and
obtaining, based on the number of vertical beams and the number of horizontal beams at the second beam level, the vertical beam width and the horizontal beam width of each beam at the second beam level.

In an example embodiment, obtaining, based on the predicted traffic of each beam coverage area of the first beam level, the number of vertical beams and the number of horizontal beams at the second beam level respectively corresponding to each beam at the first beam level, includes:
obtaining, based on the predicted traffic of each beam coverage area of the first beam level, the traffic proportion of each beam coverage area of the first beam level in the overall traffic of a cell; and
obtaining, based on the traffic proportion corresponding to each beam coverage area at the first beam level, the number of vertical beams and the number of horizontal beams at the second beam level corresponding to each beam at the first beam level.

In an example embodiment, obtaining, based on the traffic proportion corresponding to each beam coverage area at the first beam level, the number of vertical beams and the number of horizontal beams at the second beam level corresponding to each beam at the first beam level, includes:
obtaining, based on the traffic proportion corresponding to each beam coverage area at the first beam level, the total number of beams in horizontal dimension at the corresponding second beam level, and the total number of beams in vertical dimension at the corresponding second beam level, an initial number of vertical beams and an initial number of horizontal beams at the second beam level corresponding to each beam at the first beam level; and
obtaining, based on the initial number of vertical beams and the initial number of horizontal beams at the second beam level corresponding to each beam at the first beam level, the number of vertical beams and the number of horizontal beams at the second beam level.

In an example embodiment, obtaining, based on the initial number of vertical beams and the initial number of horizontal beams at the second beam level corresponding to each beam at the first beam level, the number of vertical beams and the number of horizontal beams of the second beam level corresponding to each beam at the first beam level, includes:
based on the sum of a number of beams of each beam at the second beam level corresponding to each beam at the first beam level being equal to the maximum number of beams allowed in the second beam level, regarding the initial number of vertical beams and the initial number of horizontal beams of the second beam level as the number of vertical beams and the number of horizontal beams at the second beam level respectively;
based on the sum of a number of beams of each beam at the second beam level corresponding to each beam at the first beam level not being equal to the maximum number of beams allowed in the second beam level, obtaining the number of vertical beams and the number of horizontal beams at the second beam level by adjusting the initial number of vertical beams and/or the initial number of horizontal beams of the second beam level corresponding each beam at the first beam level until the sum of number of beams of each beam at the second beam level corresponding to each beam at the first beam level is equal to the maximum number of beams allowed in the second beam level.

In an example embodiment, obtaining, based on the number of vertical beams and the number of horizontal beams at the second beam level, the vertical beam width and the horizontal beam width of each beam at the second beam level, includes:
obtaining, based on the number of vertical beams at the second beam level, the number of vertical beams at the first beam level, and a coverage width in a vertical dimension in a cell, the vertical beam width of the second beam level; and
obtaining, based on the number of horizontal beams at the second beam level, the number of horizontal beams at the first beam level, and a coverage width in a horizontal dimension in a cell, the horizontal beam width of the second beam level.

In an example embodiment, the attribute of beam includes the number of beams and/or a beam width;
wherein, the method further includes:
selecting, from a specified beam set, at least one candidate beam, based on the beam width of each beam at the second beam level; and
obtaining a correlation factor between each candidate beam and the beam of first beam level, and determining the beam at the second beam level based on the correlation factor and the number of beams of each beam at the second beam level.

In an example embodiment, selecting, from a specified beam set, at least one candidate beam, based on the beam width of each beam at the second beam level, includes:
selecting, from the specified beam set, at least one beam with a same beam width as the second beam level or a beam width in a specified range, as the candidate beam.

In an example embodiment, determining the beam at the second beam level based on the correlation factor and the number of beams of each beam at the second beam level, includes:
arranging each candidate beam in a descending order according to the value of the corresponding correlation factor, and determining the candidate beam with the number of beams ranked first as the beam at the second beam level.

Embodiments of the disclosure provide a beam management apparatus, including:
a measurement indication module comprising circuitry configured to instruct a user equipment (UE) to perform a beam measurement at a first beam level;
a measurement determination module comprising circuitry configured to determine, based on at least one of information on transmission capacity, mobility information and traffic information of the UE, whether to instruct the UE to perform a beam measurement at a second beam level; and
a beam scheduling module comprising circuitry configured to receive beam measurement results of the UE and perform beam scheduling, and
wherein, a scheduled beam includes a beam at the first beam level or a beam at the second beam level; serving cells of the base station are covered by each of the beam levels, and beams at different beam levels have different attributes.

In an example embodiment, based on the scheduled beam being the beam at the first beam level, the beam scheduling module is configured for the UE performing measurement on the beam at the second beam level.

In an example embodiment, based on the scheduled beam being the beam at the first beam level, based on a serving beam for the UE being the beam at the second beam level, the apparatus further includes a cross-level beam scheduling module configured to:
determine, based on remaining resources of the scheduled beam and/or the information on transmission capacity of the UE, whether to adjust the serving beam for the UE to the scheduled beam.

In an example embodiment,
the attribute of the beam includes the number of beams and/or a beam width; and/or
beams at different beam levels have different widths, and the beam width of the first beam level is greater than the beam width of the second beam level; and/or
the base station corresponds to at least one second beam level.

In an example embodiment, the information on transmission capacity includes an average synchronization signal reference signal received power (SS-RSRP); and/or
the mobility information includes a beam change frequency (BCF).

In an example embodiment, the measurement determination module further includes:
a beam level determination sub-module comprising circuitry configured to determine, based on at least one of information on transmission capacity, mobility information and traffic information of the UE, the beam level corresponding to the UE;
a measurement indication sub-module comprising circuitry configured to instruct the UE to perform a beam measurement at a second beam level based on the determined beam level corresponding to the UE being the second beam level.

In an example embodiment, based on the UE currently being in the first beam level, the beam level determination sub-module is configured to:
determine, based on the information on transmission capacity and/or the mobility information of the UE, an adjusted beam level corresponding to the UE; and
determine, based on the traffic of the UE to be transmitted, whether to adjust the beam level for the UE to the adjusted beam level.

In an example embodiment, the beam level determination sub-module is further configured to:
based on the traffic of the UE to be transmitted not being zero, adjust the beam level for the UE to the adjusted beam level; and
based on the traffic of the UE to be transmitted being zero, keep the beam level for the UE constant at the first beam level and save the adjusted beam level.

In an example embodiment, based on the UE currently being in the second beam level, the beam level determination sub-module is configured to:
determine, based on at least one of the traffic of the UE to be transmitted within a specified number of consecutive slots, the information on transmission capacity and the mobility information of the UE, whether to adjust the beam level for the UE to the first beam level.

In an example embodiment, the beam level determination sub-module is further configured to:
based on the traffic of the UE to be transmitted being zero within a specified number of consecutive slots, adjust the beam level for the UE to the first beam level and save the beam level for the UE before the adjustment;
based on the information on transmission capacity of the UE indicating that the transmission capacity of the UE meets a first specified condition, adjust the beam level for the UE to the first beam level; and
based on the mobility information of the UE indicating that the mobility of the UE meets a second specified condition, adjust the beam level for the UE to the first beam level.

In an example embodiment, the beam level determination sub-module is further configured to:
based on the traffic of the UE changing from zero to non-zero, adjust the beam level for the UE to the corresponding second beam level; and
wherein, the corresponding second beam level is the last saved beam level.

In an example embodiment, based on the UE currently being in the second beam level, the beam level determination sub-module is configured to:
determine, based on at least one of the information on transmission capacity and the mobility information of the UE, whether to adjust the beam level for the UE to another second beam level.

In an example embodiment, the beam level determination sub-module is further configured to:
based on the information on transmission capacity of the UE indicating that the transmission capacity of the UE meets a third specified condition and the mobility information of the UE indicating that the mobility of the UE meets a fourth specified condition, adjust the beam level for the UE to the other second beam level.

In an example embodiment, the apparatus further includes a beam attribute determination module comprising circuitry configured to:
obtain, using a prediction model, a predicted traffic of each beam coverage area of the first beam level, based on a historical traffic of each beam coverage area in the first beam level; and
determine, based on the predicted traffic of each beam coverage area of the first beam level, the attribute of the beam at the second beam level respectively corresponding to each beam at the first beam level.

In an example embodiment, the apparatus further includes a beam predicted traffic adjustment module comprising circuitry configured to:
obtain historical information on transmission capacity of each beam at the first beam level; and
adjust the predicted traffic of each beam coverage area of the first beam level based on the historical information on transmission capacity of each beam at the first beam level.

In an example embodiment, wherein, the attribute of beam includes the number of beams and/or a beam width, the number of beams includes the number of vertical beams and the number of horizontal beams, and the beam width comprises a vertical beam width and a horizontal beam width;
the beam attribute determination module is configured to:
obtain, based on the predicted traffic of each beam coverage area of the first beam level, the number of vertical beams and the number of horizontal beams at the second beam level respectively corresponding to each beam at the first beam level; and
obtain, based on the number of vertical beams and the number of horizontal beams at the second beam level, the vertical beam width and the horizontal beam width of each beam at the second beam level.

In an example embodiment, the beam attribute determination module is further configured to:
obtain, based on the predicted traffic of each beam coverage area of the first beam level, the traffic proportion of each beam coverage area of the first beam level in the overall traffic of a cell; and
obtain, based on the traffic proportion corresponding to each beam coverage area at the first beam level, the number of vertical beams and the number of horizontal beams at the second beam level corresponding to each beam at the first beam level.

In an example embodiment, the beam attribute determination module is further configured to:
obtain, based on the traffic proportion corresponding to each beam coverage area at the first beam level, the total number of beams in horizontal dimension at the corresponding second beam level, and the total number of beams in vertical dimension at the corresponding second beam level, an initial number of vertical beams and an initial number of horizontal beams at the second beam level corresponding to each beam at the first beam level; and
obtain, based on the initial number of vertical beams and the initial number of horizontal beams at the second beam level corresponding to each beam at the first beam level, the number of vertical beams and the number of horizontal beams at the second beam level.

In an example embodiment, the beam attribute determination module is further configured to:
based on the sum of number of beams of each beam at the second beam level corresponding to each beam at the first beam level being equal to the maximum number of beams allowed in the second beam level, regard the initial number of vertical beams and the initial number of horizontal beams of the second beam level as the number of vertical beams and the number of horizontal beams at the second beam level respectively; and
based on the sum of number of beams of each beam at the second beam level corresponding to each beam at the first beam level not being equal to the maximum number of beams allowed in the second beam level, obtain the number of vertical beams and the number of horizontal beams at the second beam level by adjusting the initial number of vertical beams and/or the initial number of horizontal beams of the second beam level corresponding each beam at the first beam level until the sum of number of beams of each beam at the second beam level corresponding to each beam at the first beam level is equal to the maximum number of beams allowed in the second beam level.

In an example embodiment, the beam attribute determination module is further configured to:
obtain, based on the number of vertical beams at the second beam level, the number of vertical beams at the first beam level, and a coverage width in a vertical dimension in a cell, the vertical beam width of the second beam level; and
obtain, based on the number of horizontal beams at the second beam level, the number of horizontal beams at the first beam level, and a coverage width in a horizontal dimension in a cell, the horizontal beam width of the second beam level.

In an example embodiment, wherein, the attribute of beam includes the number of beams and/or a beam width;
the apparatus further includes a beam determination module comprising circuitry configured to:
select, from a specified beam set, at least one candidate beam, based on the beam width of each beam at the second beam level; and
obtain a correlation factor between each candidate beam and the beam of first beam level, and determining the beam at the second beam level based on the correlation factor and the number of beams of each beam at the second beam level.

In an example embodiment, the beam determination module is configured to:
select, from the specified beam set, at least one beam with the same beam width as the second beam level or a beam width in a preset range, as the candidate beam.

Embodiments of the disclosure provide a base station, the base station including a memory and a processor;
wherein the memory has computer programs and/or instructions stored therein; and
the processor is configured to execute a computer program and/or instructions to implement the method provided in the embodiment of any of the embodiments.

Embodiments of the disclosure provide a non-transitory computer readable storage medium, the computer readable storage medium having a computer program stored thereon, the computer program, when executed by the processor causes the processor to perform operations to implement the method provided in any of the embodiments.

By setting multiple beam levels, the base station is enabled to adjust the beam level for the UE according to the information on transmission capacity, the mobility information and traffic information of the UE, and the UE need not to measure the beams at all beam levels, which saves measurement overhead while ensuring the communication quality, and achieves the effect of improving the cell throughput and enhancing the user experience.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating a flow for beam management in the prior art;

FIG. 2 is a diagram illustrating a shortcoming existing in the prior art;

FIG. 3 is a diagram illustrating another shortcoming in the prior art;

FIG. 4 is a diagram illustrating yet another shortcoming in the prior art;

FIG. 5 is a flowchart illustrating an example method performed by a base station according to various embodiments;

FIG. 6A is a block diagram illustrating an example beam management method in according to various embodiments;

FIG. 6B is a block diagram illustrating an example beam management method according to various embodiments;

FIG. 7 is a diagram illustrating a comparison of characteristics of three-level beam levels according to various embodiments;

FIG. 8 is a diagram illustrating beam pattern adjustment on a periodic basis according to various embodiments;

FIG. 9A is a diagram illustrating an example in which the user performs the adaptive adjustment among three beam levels according to various embodiments;

FIG. 9B is a diagram illustrating an example in which different users are allocated with different beam levels according to various embodiments;

FIG. 10 is a diagram illustrating an example process of data collection and AI processing according to various embodiments;

FIG. 11 is a diagram illustrating an example AI model prediction process according to various embodiments;

FIG. 12A is a diagram illustrating an example multi-level beam pattern obtaining process according to various embodiments;

FIG. 12B is a diagram illustrating an example of an obtained multi-level beam pattern at different periods according to various embodiments;

FIG. 13 is a diagram illustrating an example obtained number of beams according to various embodiments;

FIG. 14 is a diagram illustrating example obtained beam width according to various embodiments;

FIG. 15 is a diagram illustrating an example of obtaining and determining the beam pattern according to various embodiments;

FIG. 16 is a diagram illustrating example beam level adjustment according to various embodiments;

FIG. 17 is a diagram illustrating an example starting point of a period and the ending point of the period in beam level adjustment according to various embodiments;

FIG. 18 is a diagram illustrating example beam level adjustment when the user is currently in beam level L1 according to various embodiments;

FIG. 19 is a diagram illustrating example beam level adjustment when the user is currently in beam level L2 according to various embodiments;

FIG. 20 is a diagram illustrating example beam level adjustment when the user is currently in beam level L3 according to various embodiments;

FIG. 21 is a diagram illustrating example cross-level beam scheduling and transmission according to various embodiments;

FIG. 22 is a graph illustrating a relationship between the beamforming gain and the SINR adjustment according to various embodiments;

FIG. 23 is a diagram illustrating example SINR adjustment after the beam level changes according to various embodiments;

FIG. 24 is a diagram illustrating an example deployment scheme according to various embodiments;

FIG. 25 is a block diagram illustrating an example configuration of a beam management apparatus according to various embodiments;

FIG. 26 is a diagram illustrating an example configuration of an electronic device according to various embodiments; and

FIG. 27 is a diagram illustrating an example of a wireless communication system according to various embodiments.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not be limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU -open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜module’, ‘˜unit’, ‘˜part’, ‘˜body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {‘C’, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

Various example embodiments of the disclosure are described in greater below in combination with the accompanying drawings. It should be understood that the various example embodiments set forth below in combination with the accompanying drawings are merely examples, and do not limit the scope of the disclosure.

One skilled in the art may understand that “a”, “an”, “said” and “this” may also refer to plural nouns, unless otherwise specifically stated. It should be further understood that the term “comprise/comprising” or “include/including” used in the disclosure may indicate that the corresponding features may be implemented as the presented features, information, data, steps, operations, elements and/or components, but does not exclude that they are implemented as other features, information, data, steps, operations, elements, components and/or combinations thereof supported in the art. It should be understood that, when an element is “connected to” or “coupled to” to another element, this element may be directly connected to or coupled to the another element, or this element may be connected to the another element through an intermediate element. Further, “connection” or “coupling” used herein may include wireless connection or wireless coupling. The term “and/or” used herein indicates at least one of the items defined by the term, for example “A and/or B” may be implemented as “A”, or as “B”, or as “A and B”.

The disclosure will be further described in greater detail below in combination with the accompanying drawings.

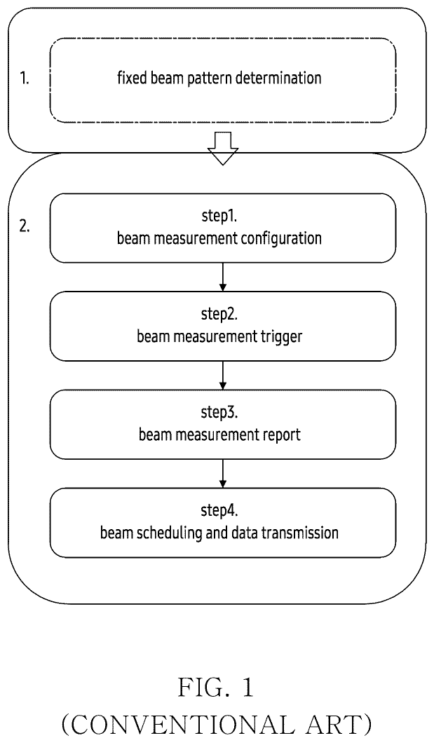

As shown in FIG. 1, the flow of beam management in conventional scheme is substantially as follows:
1. When a base station is deployed, the fixed beam pattern is selected from the pre-designed beam pattern set covering the main 5G scenarios according to the scenario;
2. After cell activation, the base station and the user perform the following beam management steps:
Step 1: The base station configures the beam measurement parameters to the user;
Step 2: The base station triggers periodic/non-periodic measurements of the beam by the user;
Step 3: The user reports the beam measurement results to the base station; and
Step 4: The base station schedules a serving beam for the user and transmits data on the serving beam.

In the above beam management scheme, the beam pattern does not change with the changes of the number of active users and the traffic in the network. Compared with 4G networks, 5G networks are more flexible and have more diversified terminals and services. The service type, service distribution and traffic of users in the network fluctuate with time, and the demand for beam pattern also changes with time. However, the configured beam pattern is not adjusted with time and cannot dynamically match the needs of 5G services. Therefore, the above scheme mainly has at least the following problems:

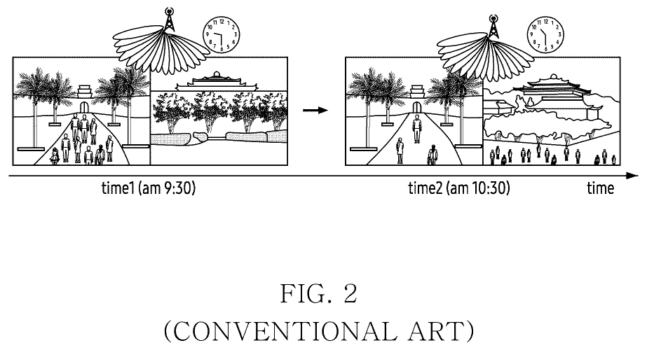

The first aspect is that a fixed beam pattern may lead to an unreasonable allocation of beam resources, so that the changing service scenarios cannot be met. As shown in FIG. 2, a beam of a cell may cover a plurality of different traffic distribution scenarios, and the traffic distribution in the same cell may be different at different times. In the area with a large number of users and big traffic, a small number of wide beams cannot provide large beamforming gain, and the throughput of the cell is low, which cannot meet the transmission needs of a large number of users, resulting in poor user experience (including intermittent voice calls, low download rate, poor web browsing/game/video experience, etc.). In the area with small traffic, the beam utilization rate is low, which will lead to the waste of beam resources.

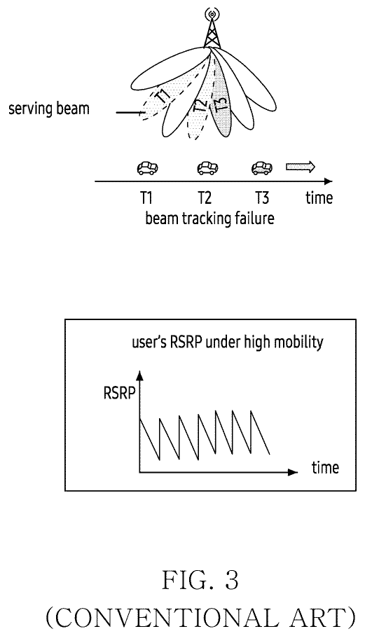

The second aspect is that when the beam pattern deployed by the base station is narrow, the communication requirements of users moving at a high speed cannot be met. As shown in FIG. 3, for users moving at a high speed, the serving beam may switch frequently, and the reference signal received power (RSRP) for the user will fluctuate greatly, which will result in poor user experience and may lead to beam tracking failure (the servicing beam cannot track the user's position in time, leading to data transmission interruption), and even cause the user to drop the line.

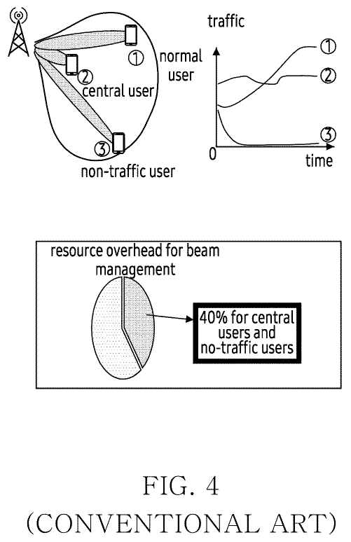

The third aspect is that unnecessary narrow beam measurements for some users (for central and non-traffic users) can result in a waste of resources. As shown in FIG. 4, narrow beams can bring higher beamforming gain, but more time-frequency resources are needed for beam management. The central users can achieve high quality transmission even without high beamforming gain. There is no data transmission for non-traffic users and no beam measurement is required. These unnecessary resource overhead may reduce the data transmission resources and reduce the throughput of the cell.

In view of the above problems, various embodiments of the disclosure provide a method performed by a base station, which is described in greater detail below.

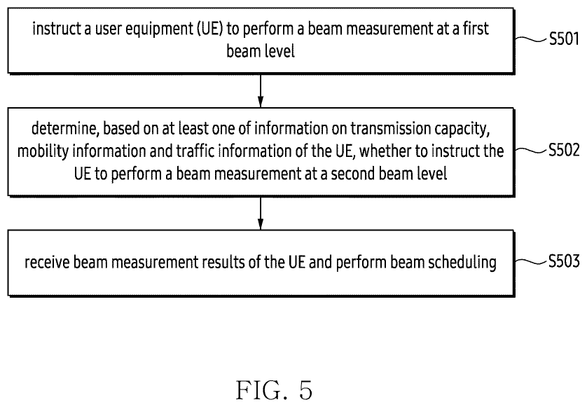

FIG. 5 is a flowchart illustrating an example method performed by a base station according to various embodiments. As shown in FIG. 5, the method may include:

Operation S 501: instructing a user equipment (UE) to perform a beam measurement at a first beam level;

Wherein, the beam pattern corresponding to the first beam level may be preconfigured by the base station or may be determined later according to the communication requirements of the cell.

Operation S502: determining, based on at least one of information on transmission capacity, mobility information and traffic information of the UE, whether to instruct the UE to perform a beam measurement at a second beam level.

Wherein, the information on transmission capacity includes an average synchronization signal reference signal received power (SS-RSRP); and/or the mobility information comprises a beam change frequency (BCF).

Wherein, the beam pattern of the second beam level may be preconfigured by the base station or may be determined later according to the communication requirements of the cell.

For example, the base station determines whether to instruct the UE to perform a beam measurement at a second beam level, based on at least one of information on transmission capacity, mobility information and traffic information of the UE. In other words, the UE does not necessarily perform the beam measurement at the second beam level, and the base station does not instruct the UE to perform the beam measurement at the second beam level in some cases.

Operation S503: receiving beam measurement results of the UE and performing beam scheduling.

Wherein, a scheduled beam is a beam at the first beam level or a beam at the second beam level; serving cells of the base station are covered by each of the beam levels, and beams at different beam levels have different attributes.

For example, the beam scheduling is performed according to the measurement results of the UE. It may be understood that the measurement results may include the measurement results for the beam at the first beam level and in some cases may also include the measurement results for the beam at the second beam level.

According to various embodiments, by setting multiple beam levels, enables the base station to adjust the beam level for the UE according to the information on transmission capacity, the mobility information and traffic information of the UE, and the UE need not to measure the beams at all beam levels, which saves measurement overhead while ensuring the communication quality, and achieves the effect of improving the cell throughput and enhancing the user experience.

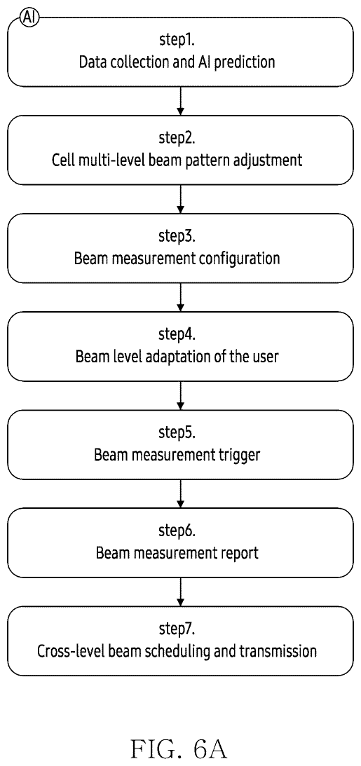

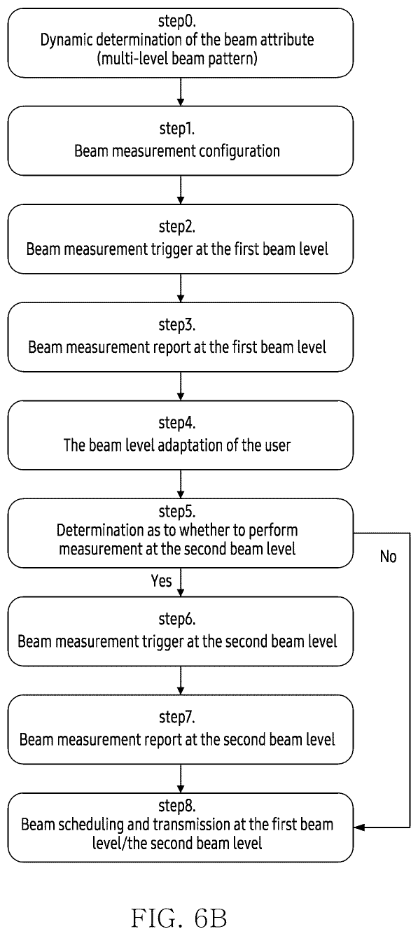

As illustrated in FIG. 6A, the beam management scheme provided according to various may include the following steps. It will be understood that the illustrated steps (e.g., operations) are not limited to the following steps and that additional or fewer steps may be performed and further that there is no limitation on the order of steps illustrated in the diagrams of the instant disclosure.
Step 1: The base station performs data collection and artificial intelligence (AI) prediction;
Step 2: The base station adjusts the cell multi-level beam pattern;
Step 3: The base station configures the beam measurement for the UE;
Step 4: The beam level adaptation of the user (e.g., UE);
Step 5: Beam measurement trigger;
Step 6: The base station receives the beam measurement report; and
Step 7: cross-level beam scheduling and transmission.

Further, as illustrated in FIG. 6B, the beam management scheme according to various embodiments may further include the following steps:
Step 0: dynamic determination of the beam attribute, e.g., the number of beams and the beam width corresponding to each beam level in multi-level beam pattern are determined dynamically;
Step 1: The base station configures the beam measurement for the UE;
Step 2: The base station triggers the beam measurement on the first beam level;
Step 3: The base station receives the beam measurement report of the first beam level;
Step 4: The beam level adaptation of the user;
Step 5: Determination is made as to whether to instruct the UE to perform measurement at the second beam level; if so, proceed to Step 6; if not, proceed to Step 8;
Step 6: The base station triggers the beam measurement at the second beam level;
Step 7: The base station receives the beam measurement report of the second beam level; and
Step 8: The beam scheduling and transmission are performed.

The above-mentioned beam management scheme may be implemented based on the multiple beam levels illustrated in various embodiments of the disclosure. The implementation of the beam management scheme includes :(1) adjusting the cell multi-level beam pattern; (2) the beam level adaptation of the user; (3) determining whether to instruct the UE to perform beam measurement at the second beam level; and (4) cross-level beam scheduling and transmission. Specifically:

(1) Adjustment of the Cell Multi-Level Beam Pattern

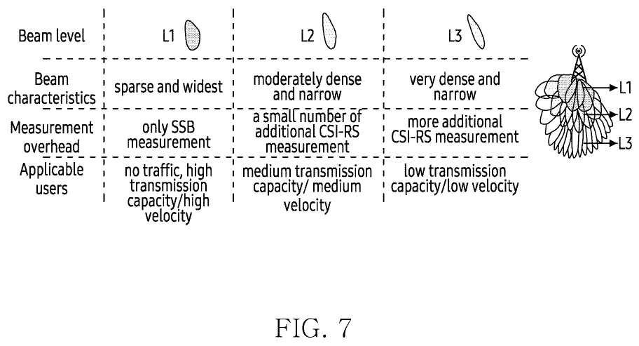

Based on the predicted traffic of each beam coverage area of the first beam level and the transmission capacity of each beam, the cell multi-level beam pattern is adjusted intelligently to match dynamic and diverse service scenarios, which addresses the problem involved in the first aspect as described above.

Wherein, the multi-level beam pattern is a group of beam patterns for beam measurement and data transmission, and wherein each of the beam patterns covers the same area. The level of the beam pattern is determined based on coverage level, mobility, traffic distribution and measurement overhead. A three-level beam pattern is a typical value, which can meet the needs of most scenarios. Therefore, the disclosure is next illustrated with a three-level beam pattern as an example. Wherein, the beam at beam level L1 is denoted as the L1 beam, the beam at beam level L2 is denoted as the L2 beam, and the beam at beam level L3 is denoted as the L3 beam. The beam characteristics of the beams at each level are different and applicable to users of different statuses, as shown in FIG. 7, where SSB is the synchronization signal block. CSI-R is the channel status information reference signal. In an embodiment, the first beam level may correspond to the above beam level L1, and the second beam level may correspond to the above beam levels L2 and L3.

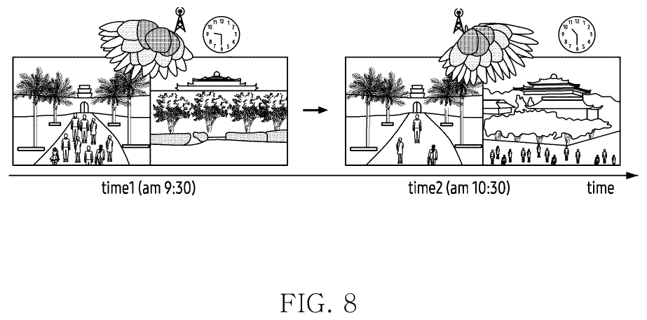

An example is illustrated in FIG. 8. Through the disclosure, the three-level beam pattern of each cell will be implemented, adjusted over time on a periodic basis to match the requirements for traffic in different coverage areas within the cell.

(2) The Beam Level Adaptation of the User

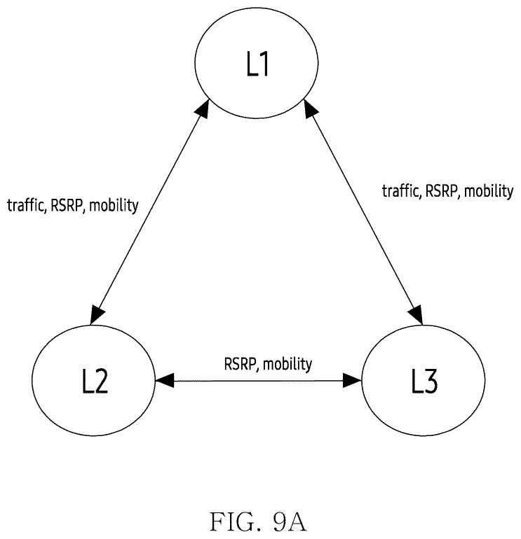

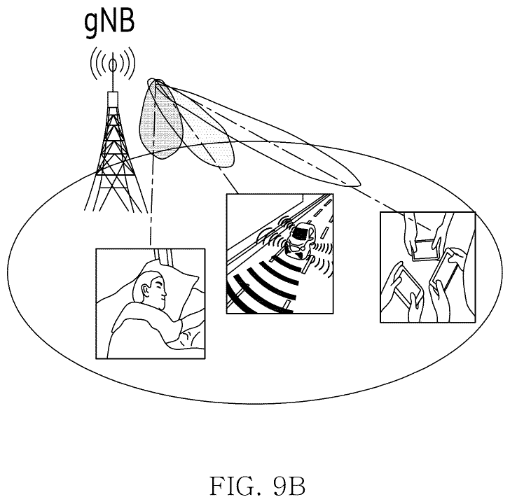

As illustrated in FIG. 9A, the beam level for each user is adaptively adjusted based on the transmission capacity, mobility and traffic of the user to adapt to the change in user requirements. There may be two trigger mechanisms for the adjustment of the beam level for the user:

Periodical trigger: the beam level for the user is adjusted every certain period according to the transmission capacity and mobility the user to match the change in the user status.

Event trigger: the beam level for the user is adjusted timely according to the traffic of the user, so that the user can be adjusted to an appropriate beam level timely and the measurement overhead can be reduced.

Through the beam level adaptation of the user, the following can be achieved:

Users with higher mobility will be allocated on the L1 or L2 beams, ensuring the performance of the beam tracking. It can address the problem involved in the second aspect as described above. As illustrated in FIG. 9B, the user located in a high-speed car is allocated to the L2 beams.

Non-traffic users or users with high channel quality will be allocated on the L1 beam, thereby reducing the overhead and improving the transmission performance of the system. It can address the problem involved in the third aspect as described above. As shown in FIG. 9b, the user located in a high-speed car is allocated to the L1 beams.

The beam management scheme in various embodiments can reduce the beam measurement overhead of the user, because the UE is only required to measure all L1 beams and a small fraction of the L2/L3 beams (the users allocated to L1 beams are not required to measure the L2/L3 beams) instead of needing to measure all L2/L3 beams, or the UE is only required to measure the L1 beams without measuring the L2 and L3 beams.

(3) Determination as to Whether to Instruct the UE to Perform Beam Measurement at the Second Beam Level

In some cases, the base station does not indicate the UE to measure the beam at the second beam level. In various embodiments, the base station will instruct the UE to measure the beam at the second beam level only when the beam level corresponding to the UE is the second beam level, thereby being capable of reducing the beam measurement overhead of the user.

(4) Cross-Level Beam Scheduling and Transmission

Flexible cross-level beam scheduling can maximize and/or improve resource utilization and improve cell performance Users whose beam level is determined to be L2/L3, can be temporarily scheduled with corresponding L1 beam, because the L1 beam and the corresponding L2/L3 beam cover the same area. Even if the beam level for the user is determined to be L2/L3, since the beam measurement on the L1 beam (SSB measurement) is kept performed all the time, the user can be temporarily scheduled with corresponding L1 beam.

An example beam management method of the disclosure will be illustrated below, and the implementation process of the above points is illustrated in detail.

The base station needs to collect data and performs AI prediction based on the collected data, e.g., performing the data collection and AI processing in step (1). In other words, a predicted traffic of each beam coverage area of the first beam level is obtained based on a historical traffic of each beam coverage area in the first beam level, using a prediction model.

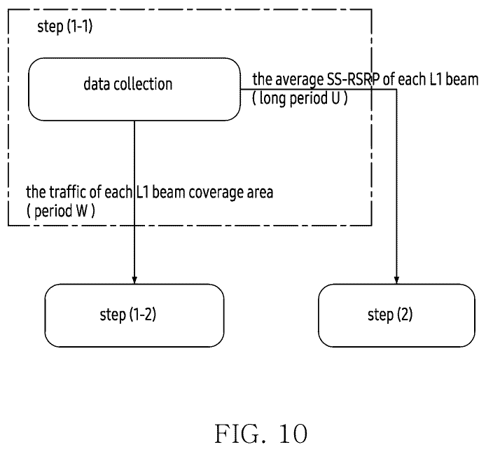

In this step, based on the traffic of each L1 beam coverage area in the last period W, the traffic of each L1 beam coverage area in the next period W is predicted by the AI model. Meanwhile, the average SS-RSRP of each L1 beam for each long period U is counted and used in step (2). As shown in FIG. 10, the step (1) may include a step (1-1) data collection and a step (1-2) AI model-based data predication, for example:

Step (1-1) Data Collection

This step is used to collect the traffic of each L1 beam coverage area of the base station in the last period W, which is used as the input of the AI model. The average SS-RSRP of each L1 beam is calculated according to the long period U. Wherein, the long period U is greater than the period W. For example, the long period U may be 1 day, and the corresponding period W may be 1 hour.

For example, the collected traffic TL(i) of each L1 beam coverage area (including L2 or L3 beams) (i refers to the sequence number of the L1 beam) is used as the input of the AI model. In this step, statistics on data are carried out periodically, and the data is collected once per period W.

In addition, the average SS-RSRP of each L1 beam is calculated and updated according to the gap between the two long periods U, mainly considering the impact of environmental changes (such as building a new building). The process can include: Temp_RSRP₍ᵢ₎(t)
(a) The average SS-RSRP of the user under each L1 beam is collected;
(b) The average SS-RSRP of each L1 beam within a long period U is calculated and denoted as Temp_RSRP₍ᵢ₎(t) (i refers to the sequence number of the L1 beam);
(c) The final average SS-RSRP of each L1 beam within a long period U is calculated:

If |Temp_RSRP₍ᵢ₎(t)−Temp_RSRP₍ᵢ₎(t−1)|≤TH_gap, RSRP₍ᵢ₎(t)=Avg(Temp_RSRP₍ᵢ₎(t), RSRP₍ᵢ₎(t−1)), otherwise, RSRP₍ᵢ₎(t)=Temp_RSRP₍ᵢ₎(t). Wherein RSRP₍ᵢ₎(t) is the final average SS-RSRP, Temp_RSRP₍ᵢ₎(t) is the average SS-RSRP of the L1 beam with sequence number i in the current long period U, Temp_RSRP₍ᵢ₎(t−1) is the average SS-RSRP of the L1 beam with sequence number i in the last long period U, and Avg(Temp_{RSRP}_{₍ᵢ₎}(t), RSRP₍ᵢ₎(t−1)) is the average of Temp_RSRP₍ᵢ₎(t) and Temp_RSRP₍ᵢ₎(t−1).

In this step, the calculated average SS-RSRP will be used for the next long period U. The SS-RSRP of each L1 beam characterizes the transmission capacity of that L1 beam.

Step (1-2) Data Prediction Based on AI Model.

To predict the traffic TL(i) in each L1 beam coverage area of the next period W, traditional methods (such as linear filtering, Infinite Impulse Response (IIR) filtering, etc.) or AI-based methods (such as Supported vector Regression (SVR) and Long short-term Memory (LSTM)) can be adopted.

For example, an embodiment can use the SVR method to predict the traffic in each L1 beam coverage area. Assuming that the predication duration is one period W (for example, 60 minutes), the prediction model outputs the following parameters: the traffic of the first L1 beam coverage area (e.g., the predicted traffic), the traffic of the second L1 beam coverage area, and the traffic of the third L1 beam coverage area, etc. The predicted traffic xo for each L1 beam coverage area in the next period W is predicted by the previous N values {x_{-B}, x_{-(N-1)}, . . . , x₋₁}. The N values are the traffic of each L1 beam coverage area for the previous N period Ws.

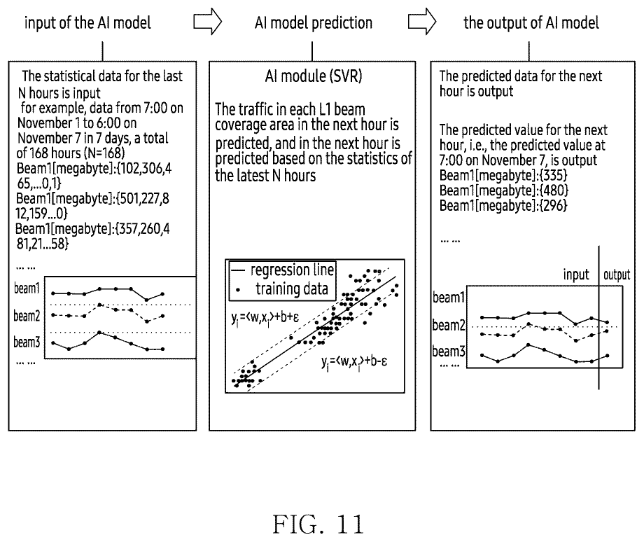

As shown in FIG. 11, for example, to predict the parameters of the period W (1 hour) starting from 7:00 on November 7, it is necessary to input the data of the previous 7 days (from 7:00 on November 1 to 6:00 on November 7), then the total number of pieces of data is N=(7*24=168). Each data contains the traffic of each L1 beam coverage area. Then the 168 pieces of data are input into the AI model to obtain the data of the next period W.

Step (2) cell multi-level beam pattern adjustment. For example, the attribute of beam at the second beam level respectively corresponding to each beam at the first beam level is determined based on the predicted traffic of each beam coverage area of the first beam level.

The conventional beam pattern is a fixed beam pattern at one level. Because the traffic of different areas in the cell is different, and the traffic of the same area is also different in different time periods, for scenarios with high traffic, the conventional solution cannot meet the service requirements, and for scenarios with low traffic, the beam utilization rate is low and the beam resources are wasted. Therefore, the conventional scheme cannot match the traffic scenarios and there is the problem of unreasonable beam resource allocation.

According to various embodiments of the disclosure, the multi-level beam pattern is adjusted to match a variety of dynamically changing service scenarios based on the transmission capacity of each L1 beam and the traffic of each L1 beam coverage area predicted by AI. The close coordination between beam resources and traffic is obtained, which effectively improves the system throughput and avoids the waste of beam resources. The scheme takes the distribution of traffic and the transmission capacity of L1 beam in different scenarios into account to address the problem involved in the first aspect as described above.

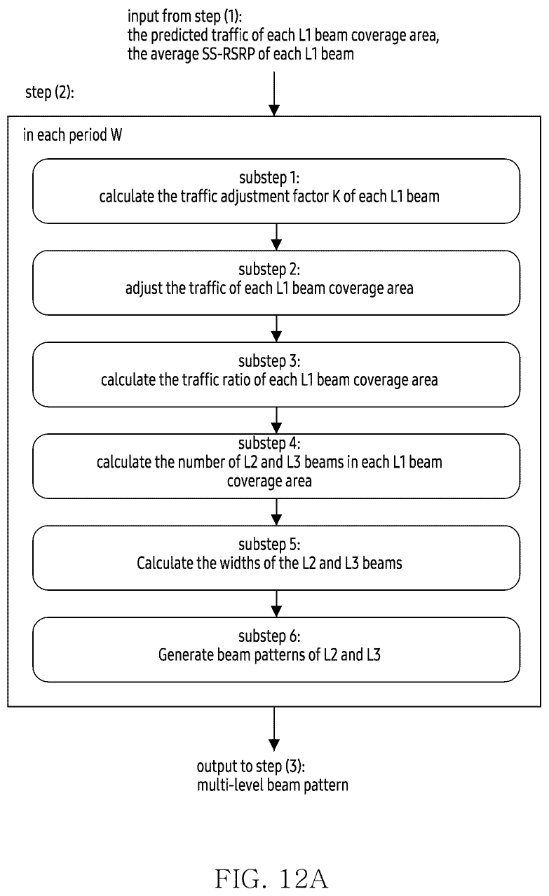

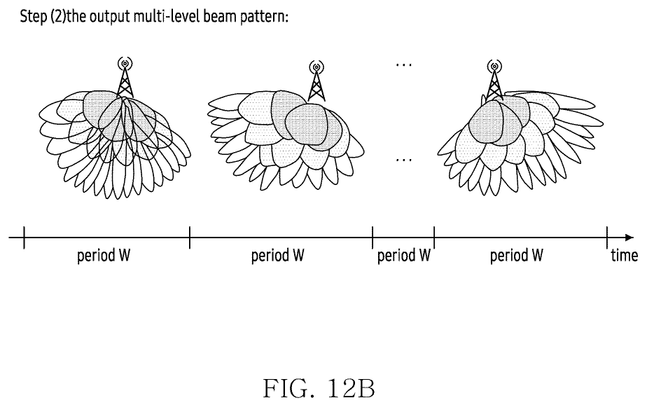

For example, as illustrated in FIGS. 12A and 12B, according to various embodiments, step (2) may further include substeps 1 to 6, for example:

In an example embodiment, the method further includes:
obtaining historical information on transmission capacity of each beam at the first beam level; and
adjusting the predicted traffic of each beam coverage area of the first beam level based on the historical information on transmission capacity of each beam at the first beam level.

For example, before using the predicted traffic of L1 beam obtained in step (1), the predicted traffic by AI prediction can also be adjusted according to the historical information on transmission capacity of each beam. This process can be implemented through the following sub-step 1 and sub-step 2.

Substep 1: the traffic adjustment factor for each L1 beam coverage area is calculated.

In order to accurately reflect the transmission capacity of the L1 beam, Shannon formula, which measures the channel capacity, is used to calculate the traffic adjustment factor of each L1 beam coverage area, β₍ᵢ₎, the specific formula is as follows:

β₍ᵢ₎=log₂(1RSRP₍ᵢ₎−N1)

Wherein, i is the number of L1 beam, RSRP₍ᵢ₎ is the average reference signal received power from step (1-1), that is, the historical information on transmission capacity of each beam, N1 denotes the estimated cell interference which is a configurable value.

Substep 2: the traffic of each L1 beam coverage area is adjusted.

In order to better reflect the beam resource requirements of the L1 beam coverage area, the traffic adjustment factor of each L1 beam coverage area obtained in substep 1 above is used to adjust the traffic of each L1 beam coverage area by AI prediction. The specific formula is as follows:

$$T {L}_{( i )} = \frac{T {L}_{( i )}}{{β}_{( i )} / {β}_{m i n}} \qquad ( i )$$

Wherein, TL₍ᵢ₎ is the traffic predicted by AI from step (1-2), and βₘᵢₙ is the smallest value among β_{(i).}

In an example embodiment, the attribute of beam includes the number of beams and/or a beam width, the number of beams includes the number of vertical beams and the number of horizontal beams, and the beam width comprises a vertical beam width and a horizontal beam width;
wherein, determining, based on the predicted traffic of each beam coverage area of the first beam level, the attribute of the beam at the second beam level respectively corresponding to each beam at the first beam level, includes:
obtaining, based on the predicted traffic of each beam coverage area of the first beam level, the number of vertical beams and the number of horizontal beams at the second beam level respectively corresponding to each beam at the first beam level; and
obtaining, based on the number of vertical beams and the number of horizontal beams at the second beam level, the vertical beam width and the horizontal beam width of each beam at the second beam level.

For example, the number of vertical beams and the number of horizontal beams of the corresponding L2 beam and the L3 beam are first obtained through the predicted traffic of each L1 beam coverage area. Then the vertical beam widths and the horizontal beam widths of the L2 beam and the L3 beam are obtained respectively based on the obtained number of vertical beams and number of horizontal beams of the L2 beam and the L3 beam, e.g., the attributes of the L2 beam and the L3 beam are obtained. This process can be implemented through the sub-step 3 to sub-step 5.

Substep 3: the traffic ratio of each L1 beam coverage area (e.g., the traffic proportion, TL_ratio₍ᵢ₎) is calculated.

The ratio of the traffic of each L1 beam coverage area to the cell traffic (e.g., the overall cell traffic) is calculated using the following equation:

$${TL\_ratio}_{( i )} = \frac{T {L}_{( i )}}{{Σ}_{i} T {L}_{( i )}} \times 100 \% \qquad ( i )$$

Substep 4: the number of L2 and L3 beams in each L1 beam coverage area is c calculated.

In order to make the beam allocation of L2 and L3 more in line with the changing service requirements, more beams of L2 and L3 are allocated to the L1 beam coverage area with high traffic, and fewer beams of L2 and L3 are allocated to the L1 beam coverage area with low traffic. According to the traffic requirements of each L1 coverage area, the number of horizontal and vertical beams will be assigned to the corresponding beams of level k in each L1 beam. The higher the traffic of the L1 beam, the more beams of level k will be allocated. In particular, the formula for calculating the number of beams N_h_{(k,i)} in the horizontal dimension for the level k in the i-th L1 beam coverage area is as follows. The calculating formula for calculating the number of beams N_v_{(k,i)} in the vertical dimension for the level k in the i-th L1 beam coverage area is the same as or similar to that for the horizontal dimension:

$${N\_h}_{( k , i )} = max ( min ( floor ( {NT\_h}_{( k )} \times T {L}_{r a {tio}_{( i )}} ) , M {n}_{( k )} ) , 1 )$$

$$( wherein , {Mn}_{( k )} = \frac{{NT\_h}_{( k )} \times ε}{{NT\_h}_{( 1 )}} )$$

Wherein,
k is the level of the beam, e.g., k=2,3 . . . ;
NT_h₍ₖ₎ is the total number of beams of level k in horizontal dimension in a cell, and is a system configured parameter, the configuration of which depends on the cell coverage and the system overhead;
NT_h₍₁₎: is the total number of beams of level 1 in horizontal dimension in a cell, and is a system configured parameter, the configuration of which depends on the cell coverage and the system overhead;
NT_v₍ₖ₎ is the total number of beams of level k in vertical dimension in a cell, and is a system configured parameter, the configuration of which depends on the cell coverage and the system overhead;
NT_v₍₁₎ is the total number of beams of level 1 in vertical dimension in a cell, and is a system configured parameter, the configuration of which depends on the cell coverage and the system overhead;
ε is configurable to limit the maximum number of beams of levels 2 and 3 that can be assigned within an L1 beam coverage area;
floor( [symbol] ) is the downward rounding operation performed on the numerical value in the parentheses;
max( [symbol] ) and min( [symbol] ) are taking the maximum and the minimal respectively for the plurality of numerical value in the parentheses.

It should be noted that the total number of beams of the level k under each L1 beam coverage area needs to meet the limit (e.g., the maximum number of beams allowed by the level k) of the number of the beams of the level k in the cell. If the limit on the number of beams is not met, then the number of beams in the horizontal dimension and vertical dimension of level k within each L1 beam may be adjusted as follows:
1) Determination is made as to whether the total number of beams of the level k exceeds the maximum number of beams of level k allowed by the cell configuration (e.g., the maximum number of beams allowed by the level k):

gap_num=Σᵢ(N_h_{(k,i)}×N_v_{(k,i)})−(NT_h₍ₖ₎×NT_v₍ₖ₎)≠0
2) If gap_num>0 (e.g., the maximum number of beams of level k allowed by the cell configuration is exceeded):
one beam of the level k is removed from the gap_num L1 beams allocated with a relatively large number of beams of level k, the removed one beam of the level k is selected from the horizontal dimension beams or vertical dimension beams with a relative larger number. That is, for L1 beams where niether N_h(k,i) nor N_h(k,i) is 1, these L1 beams are arranged in descending order according to the size of N_h(k,i)N_v(k,i). For the arranged L1 beams, if its N_h(k,i)>N_v(k,i), 1 is subtracted from N_h(k,i), otherwise 1 is subtracted from N_v(k,i), and then gap_num is recalculated until gap_num is 0.
3) If gap_num<0 (e.g., the maximum number of beams of level k allowed by the cell configuration is not exceeded):

After the distribution of beams of level k according to the proportion of service volume is completed, if there is still a surplus, one beam of the level k is added to gap_num L1 beams allocated with a relatively small number of level k beams respectively, the added one beam of the level k is selected from the horizontal dimension beams or vertical dimension beams with a relative small number. That is, for L1 beams with neither N_h(k,i) nor N_v(k,i) reaching Mn(k), these L1 beams are arranged in ascending order according to the size of N_h(k,i)N_v(k,i). For the arranged L1 beams, if its N_h(k,i)<N_v(k,i), 1 is added to N_h(k, i), otherwise 1 is added to N_v(k, i), and then gap_num is recalculated until gap_num is 0.

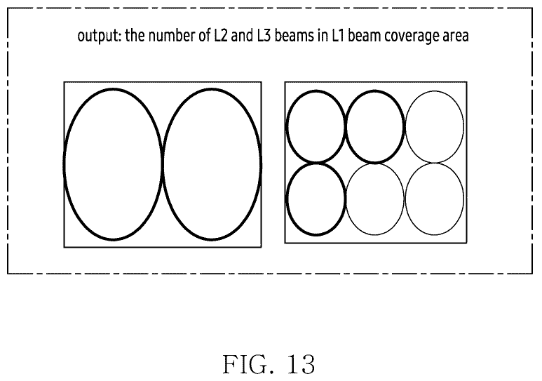

As illustrated in FIG. 13, the number of beams of the L2 beams and the L3 beams in each L1 beam coverage area will be output after this step.

Substep 5: the widths of L2 and L3 beams are calculated.

In order to make the beams of L2 and L3 uniformly distributed in the L1 beam coverage area, the horizontal width W_h_{(k,i)} of the beam of level k in the i-th L1 beam coverage area can be calculated according to the following formula. The vertical width of the beam of level k in the i-th L1 beam coverage area is calculated in the same way:

$${W\_h}_{( k , i )} = \frac{WT\_h}{{NT\_h}_{( 1 )} \times {N\_h}_{( k , i )}}$$

Wherein,
WT_h: the cell coverage width of all beams in horizontal dimension in the cell.

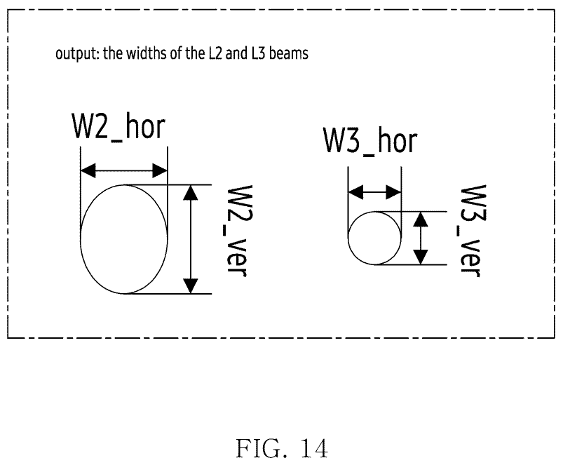

As illustrated in FIG. 14, this step outputs the width of each of the L2 beam and the L3 beam, wherein W2_hor represents the horizontal width of beam W2 and W2_ver represents the vertical width of beam W2.

In an embodiment, the attribute of beam includes the number of beams and/or a beam width; the method may further include:
selecting, based on the beam width of each beam at the second beam level, at least one candidate beam from a preset beam set; and
obtaining a correlation factor between each candidate beam and the beam of first beam level, and determining the beam at the second beam level based on the correlation factor and the number of beams of each beam at the second beam level.

For example, after determining the beam width and number of each of the L2 beam and the L3 beam, the beam pattern of each of the L2 beam and the L3 beam can be further determined, that is, each of the L2 beam and the L3 beam can be determined. This process can be implemented through the sub-step 6.

Substep 6: The beam patterns of L2 and L3 are generated, that is, the L2 beam and the L3 beam are obtained.

The beam patterns of L2 and L3 in the cell are determined based on the beam set pre-defined by the system. The beam set pre-defined by the system (e.g., the preset beam set) is a beam set containing different beam directions and different beam widths:
1) For the i-th L1 beam, a beam subset with the beam width close to [W_h_{(k,i)}, W_v_{(k,i)}] is selected from the beam set pre-defined by the system as the candidate beam of level k;
2) The correlation factor between each beam in the above candidate beam subset and its L1 beam, Corr_R_{(k,i,j)}, is calculated, which reflects the directional coherence between these two beams; the larger the value, the closer the directions of these two beams are, the correlation factor can be calculated by the following formula:

Corr_R_{(k,i,j)}=L1_beam_weight₍ᵢ₎×Hermitian(beam_weight_{(k,i,j)})

Wherein,
k is the level of the level, e.g., k=2,3;
i is the number of the L1 beam;
j is the number of the beam of the level k under the i-th L1 beam;
L1_beam_weight₍ᵢ₎: the weighted value of the i-th L1 beam;
beam_weight_{(k,i,j)} is the candidate weighted value of the j-th beam of level k under the i-th L1 beam;
Hermitian( ) is the conjugation transposition on the numerical value in the parentheses.
3) N_h_{(k,i)}×N_v_{(k,i)} beams with largest Corr_R_{(k,i,j)} are selected as the beam pattern of level k in the L1 beam coverage area.

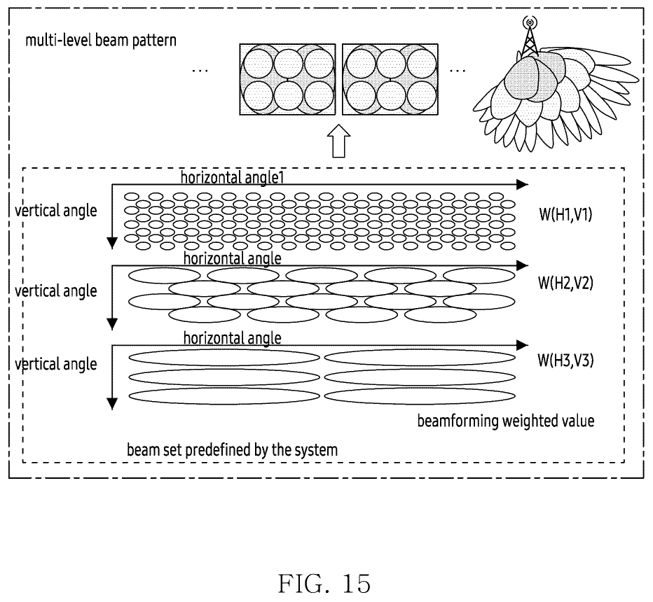

As illustrated in FIG. 15, this step outputs the beam patterns of the L2 beam and the L3 beam corresponding to each L1 beam, thus obtaining each of the L2 beam and the L3 beam.

Step (3): The Beam Level Adaptation of the User

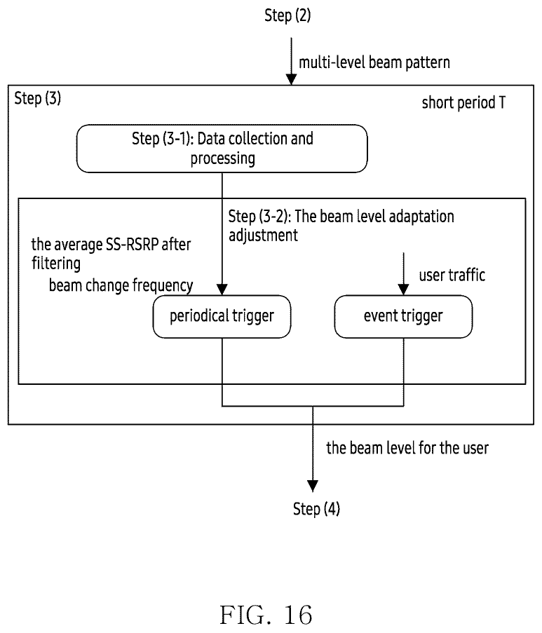

As illustrated in FIG. 16, after determining the cell multi-level beam pattern within the period W in step (2), through the dual-trigger beam level adaptation adjustment mechanism of “periodical trigger” and “event trigger”, the beam level of each user is adjusted according to the user's SS-RSRP, beam change frequency and traffic to match the dynamic change of user status.

Step (3-1): Data Collection and Processing

The average SS-RSRP and the number of beam switching of the user are collected and processed periodically to be used as the input variable for the beam level adaptation adjustment.

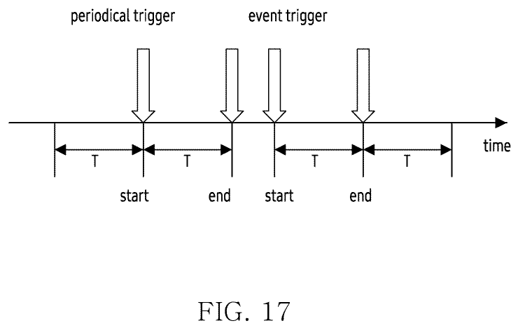

Statistics on data can be performed in unit of a short period T (e.g., 1 second). The historical collected data is cleared at the beginning of the short period T, and the collected and processed data is output to step (3-2) at the end of the short period T for determining the beam level for the user corresponding to the next short period T.

Wherein, as illustrated in FIG. 17, the beginning of the period is conditioned on: upon the initial access of the user, the end of the last short period T, or after the beam level for the user is adjusted by event trigger. The end of the period is conditioned on the elapse of time T since the beginning of the period.
(1) the average SS-RSRP of the user is collected to reflect the transmission capacity of a channel, and data filtering is performed to avoid the impact of the abnormal data, thus a more reliable average SS-RSRP can be obtained.

Digital filter technology, such as Finite Impulse Response (FIR) and Infinite Impulse Response (IIR), may be adopted.

When an IIR filter is adopted, the calculation method is as follows:

UE_{FilteredRSRP}=(1−α)*UE_{FilteredRSRPLast}+α*UE_{realTimeRSRP}

Wherein,
UE_{FilteredRSRPLast}: the average SS-RSRP after the filtering for the last period;
UE_{realTimeRSRP}: the average SS-RSRP for the current period; it may be the last value before the end of the period or the average of all values collected within the period; and
α: an adjustable filtering weighing parameter.
(2) In practical applications, it is difficult for the base station to determine the user's speed, but BCF can be used to reflect the user's mobility according to the characteristics that the faster the user moves, the more frequent the beam switching. The BCF is obtained by calculating the number of beam switching of the user on the beam level within a short period T. Under the same conditions, the larger the BCF of the user, the faster the user moves.

Step (3-2): The Beam Level Adaptation Adjustment of the User

In this step, the beam level for each user is adjusted using the dual-trigger beam level adaptation adjustment mechanism of “periodical trigger” and “event trigger” to adapt to the change of user status.

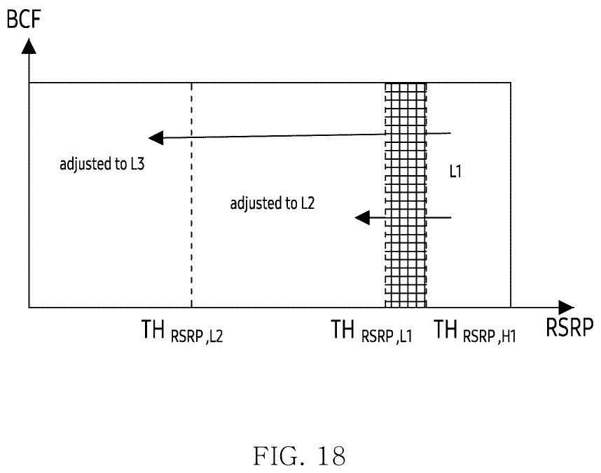

(I) periodical trigger: within each short period T, the beam level for the user is adjusted according to the average SS-RSRP (simply referred to as RSRP in the step) and collected and processed in step (3-1) and the BCF (e.g., the beam level corresponding to the user is determined) to match the changing user status in time. The adjustment algorithm varies according to the beam level the user is currently in.
(1) As illustrated in FIG. 18, when the user is in L1, the adjusted beam level is determined according to the RSRP, BCF and traffic of the user:
\textcircled{1} Users who meet the following conditions at the same time (with traffic, low mobility, and medium RSRP) are adjusted to L2 to slightly improve the signal quality and avoid excessive overhead.

DL UE_{BO}+UL UE_{BO}≠0

UE_{BCF}=0

UE_{FilteredRSRP}<THRSRP,L1 and UE_{FilteredRSRP}>THRSRP,L2
wherein, DL UE_{BO} denotes the current downlink (from the base station to the user) traffic for the user, UL UE_{BO} denotes the current uplink (from the user to the base station) traffic for the user, UE BCF denotes the BCF value for the user derived for the last short period T, and THRSRP,L1 and THRSRP,L2 are two preset RSRP threshold values.
\textcircled{2} Users who meet the following conditions at the same time (with traffic, low mobility, and low RSRP) are adjusted to L3 to greatly improve the signal quality.

DL UE_{BO}+UL UE_{BO}≠0

UE_{BCF}=0

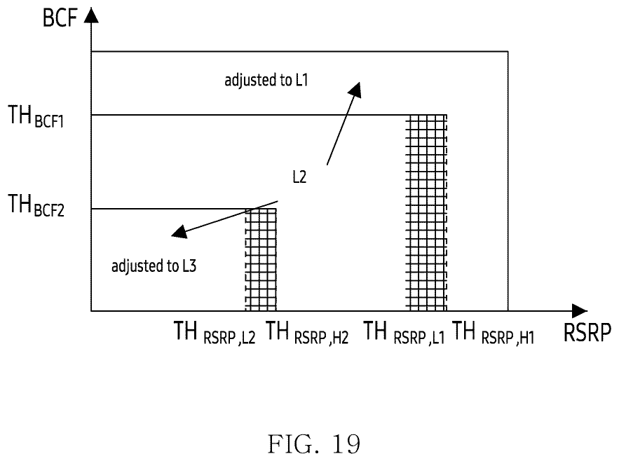

UE_{FilteredRSRP}<THRSRP,L2
\textcircled{3} For users with no traffic, if they are adjusted to L2 or L3 (that is, the corresponding adjusted beam level), the beam measurement overhead will be increased, which is unnecessary. Therefore, the beam levels for the users will not be adjusted, only the determinations in the above \textcircled{1} and \textcircled{2} are performed, and the obtained beam level will be saved as a variable UE_{SBL}.
\textcircled{4} For the users who do not meet the above conditions (\textcircled{1}, \textcircled{2}, \textcircled{3}), the current beam level for the users are kept unchanged.
(2) As illustrated in FIG. 19, when the user is at L2, the adjusted beam level is determined according to the RSRP and BCF of the user:
\textcircled{1} Users who meet one of the following conditions (high mobility or high RSRP) are adjusted to L1 to avoid the beam tracking failure or reduce the measurement overhead.

UE_{BCF}>TH_{BCF1}

UE_{FilteredRSRP}>TH_{RSRP,H1}
wherein, THBCF1 is a preset BCF threshold value.
\textcircled{2} Users who meet the following conditions at the same time (low mobility and low RSRP) are adjusted to L3 to improve the signal quality.

UE_{BCF}<TH_{BCF2}

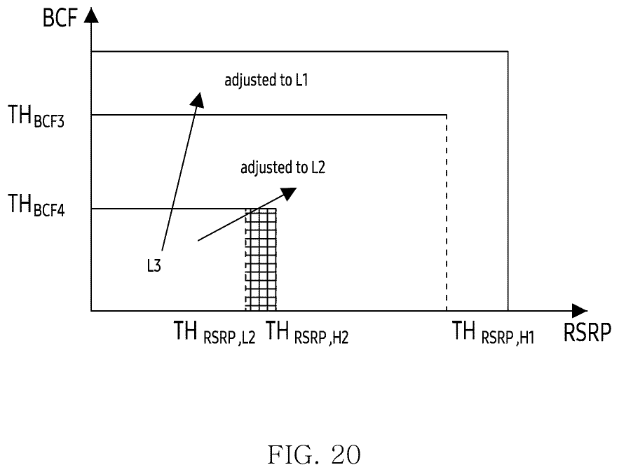

UE_{FilteredRSRP}<TH_{RSRP,L2}
wherein, THBCF2 is a preset BCF threshold value.
\textcircled{3} For the users who do not meet the above conditions (\textcircled{1}, \textcircled{2}), the current beam level for the users are kept unchanged.
(3) As illustrated in FIG. 20, when the user is at L3, the adjusted beam level is determined according to the RSRP and BCF of the user:
\textcircled{1} Users who meet one of the following conditions (high mobility or high RSRP) are adjusted to L1 to avoid the beam tracking failure or reduce the measurement overhead.

UE_{BCF}>TH_{BCF3}

UE_{FilteredRSRP}>TH_{RSRP,H1}
wherein, THBCF3 is a BCF threshold value, and THRSRP,H1 is a RSRP threshold value.
\textcircled{2} Users who meet the following conditions at the same time (medium mobility and medium RSRP) are adjusted to L2 to reduce the measurement overhead while guaranteeing the signal quality.

UE_{BCF}<TH_{BCF3} and UE_{FilteredRSRP}<TH_{RSRP,H1}

UE_{BCF}>TH_{BCF4} or UE_{FilteredRSRP}>TH_{RSRP,H2}
wherein, TH_{BCF4} is a BCF threshold value, and TH_{RSRP,H2} is a RSRP threshold value.
\textcircled{3} For the users who do not meet the above conditions (\textcircled{1}, \textcircled{2}), the current beam level for the users are kept unchanged.

Further, the grid areas in the above three drawings are buffer areas in which the beam level adjustment is not set to be performed to avoid the beam level ping pong switching for the user.

The values of the threshold values involved in the above process, including TH_{RSRP,L1}, TH_{RSRP,L2}, TH_{RSRP,H1}, TH_{RSRP,H2}, TH_{BCF1}, TH_{BCF2}, TH_{BCF3} and TH_{BCF4}, are dynamically configurable, can be determined according to the beam pattern, channel conditions, quality of service (QoS) requirements and channel load.

(II) Event trigger: the beam level is adjusted according to the traffic of the user, so that the user can be switched to an appropriate beam level more timely while reducing the measurement overhead.

When the user is at L2 or L3, in order to avoid frequent beam switching, if there is no traffic in N (for example, 10) consecutive time slots (that is, the traffic to be transmitted within a preset number of consecutive slots is zero), the current beam level is saved as a variable UE_{SBL}, and then the user is adjusted to L1 to reduce measurement overhead.

When the user is in L1, if the user changes from no traffic to traffic, the user is immediately adjusted to the beam level UE_{SBL} saved in the periodical trigger or the event trigger to guarantee the communication quality.

In addition, upon initial access of the user, the initial beam level for the user is determined according to the initial channel quality and traffic of the user: users with high RSRP or no traffic are allocated to L1 to reduce the measurement overhead, and the remaining users are allocated to L3 to enhance communication quality.

Step (4): Cross-Level Beam Scheduling and Transmission (Slot Level)

The L1 beam and the corresponding L2/L3 beam cover the same area. Even the beam level for the user is determined as L2/L3, the beam measurement on L1 beam (SSB measurement) is carried out all the time. Therefore, users whose beam level is determined as L2/L3, can be temporarily scheduled with corresponding L1 beam. This step can be divided into the following two sub-steps:

(1) Flexible Cross-Level Beam Scheduling

Users with beam level L2 or L3 can be temporarily scheduled with corresponding L1 beam for the users according the coverage level of the L1 beam and the remaining system resources, so as to maximize and/or improve resource utilization and improve cell performance.
a) The scheduling beam is selected for the base station and then the user is scheduled.
b) when the scheduling beam for the base station is a L1 beam and there is remained data resource after the completion of the resource allocation for users allocated with the L1 beam, users with beam level L2 or L3 can be temporarily scheduled with corresponding L1 beams for the users to avoid resource waste if the following two conditions are met:
The corresponding L1 beam for the user is the same as or similar to the scheduling beam for the base station; and
Users with SS-RSRP>Thr_RSRP will be selected into the scheduled queue (Thr_RSRP is a preset threshold value for selecting the user channel quality).

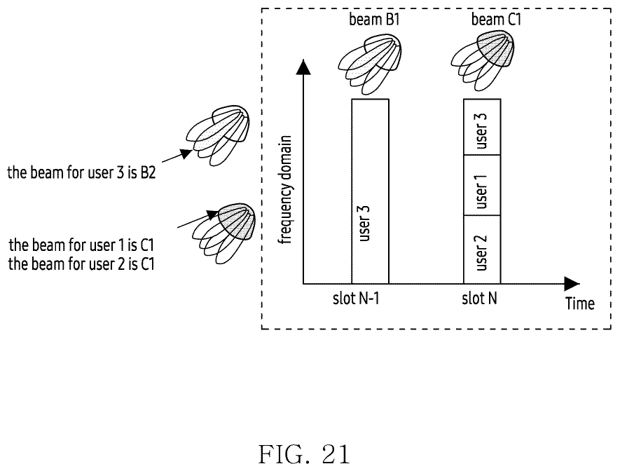

As illustrated in FIG. 21, an example is provided. When the scheduling beam for the base station is C1, there is remained data resource after the base station scheduling all users (user 1 and user 2) in beam C1. The beam for user 3 is B2 and the L1 beam corresponding to B2 is C1, then the user 3 can be temporarily scheduled with the beam C1.

(2) SINR Adjustment is Made Based on the Beamforming Gap when the Beam Changes

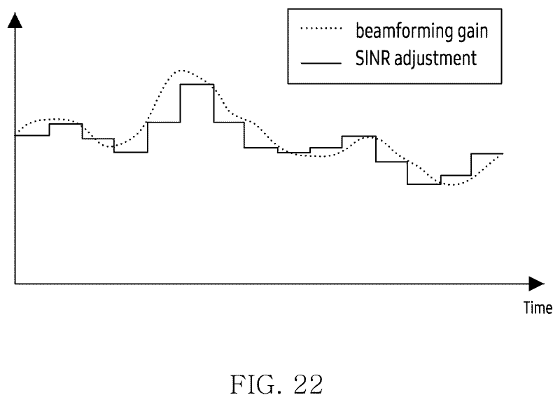

Signal to Interference plus Noise Ratio (SINR) is used for determining the Modulation and Coding Scheme (MCS) for the scheduling. As shown in FIG. 22, when the beam level for the user changes, SINR needs to be adjusted based on the beamforming gain gap in order to accurately match the channel change and improve the user's performance

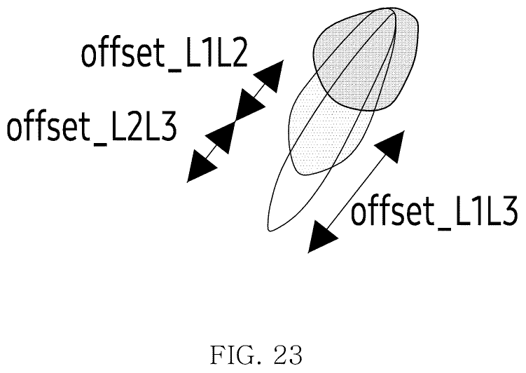

When the beam level for the UE changes, SINR_adj+=offset, SINR_adj+ is the adjusted value for the SINR. The value of offset is determined according to the beamforming gain gap at the beam level. As illustrated in FIG. 23, offset_L1L2 is the beamforming gain gap between L1 beam and L2 beam, offset_L2L3 is the beamforming gain gap between L2 beam and the L3 beam, and offset_L1L3 is the beamforming gain gap between L1 beam and L3 beam.

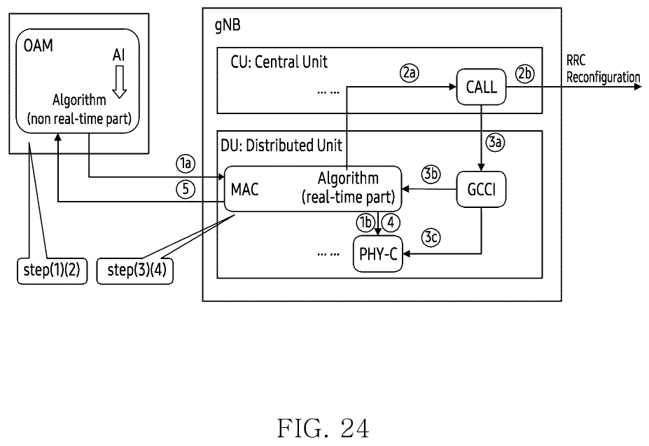

FIG. 24 is a graph illustrating a deployment scheme according to various embodiments. The non real-time part (period W part) and the AI module in the algorithm in this embodiment are deployed in the Operations, Administration and Maintenance (OAM) module of the device provider. The real-time part is deployed in the Medium Access Control (MAC) module of distributed unit (DU) of the base station. Example steps are as follows:
Step 1: After activating the cell, the OAM performs beam pattern management according to the algorithm of the disclosure, and updates the beam pattern to the MAC and Physical Layer Control (PHY-C) modules.
Step 2: When the beam pattern is initially generated or changed periodically, the MAC module will notify the CALL module to trigger the RRC reconfiguration process of the user, which is used to configure the Quasi Co Location (QCL) relationship between SSB and CSI-RS in beam management for the user.
Step 3: The CALL module notifies the MAC and PHY-C modules of the RRC configuration information through the gNB CALL Control Interface (GCCI, CALL control interface for 5G base stations).
Step 4: The MAC module performs real-time beam management based on the algorithm of the disclosure and controls PHY-C to transmit data with the preferred beam.
Step 5: The MAC module collects data and periodically reports it to the OAM for beam pattern management.

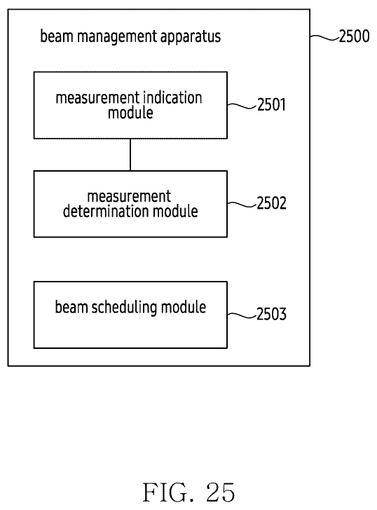

FIG. 25 is a block diagram illustrating an example configuration of a beam management apparatus according to various embodiments. As illustrated in FIG. 25, the apparatus 2500 may include: a measurement indication module (e.g., including various processing circuitry and/or executable program instructions) 2501, a measurement determination module (e.g., including various processing circuitry and/or executable program instructions) 2502 and a beam scheduling module (e.g., including various processing circuitry and/or executable program instructions) 2503, wherein:
the measurement indication module 2501 may include various circuitry and/or executable program instructions and is used to instruct user equipment (UE) to perform beam measurement at the first beam level;
the measurement determination module 2502 may include various circuitry and/or executable program instructions and is used to determine, based on at least one of information on transmission capacity, mobility information and traffic information of the UE, whether to instruct the UE to perform a beam measurement at a second beam level; and
the beam scheduling module 2503 may include various circuitry and/or executable program instructions and is used to receive beam measurement results of the UE and perform beam scheduling, and
wherein the scheduled beam is a beam at the first beam level or a beam at the second beam level; serving cells of the base station are covered by each of the beam levels, and beams at different beam levels have different attributes.

In various example embodiments of the disclosure, by setting multiple beam levels, enables the base station to adjust the beam level for the UE according to the information on transmission capacity, the mobility information and traffic information of the UE, and the UE need not to measure the beams at all beam levels, which saves measurement overhead while ensuring the communication quality, and achieves the effect of improving the cell throughput and enhancing the user experience.

In an example embodiment, if the scheduled beam is the beam at the first beam level, the beam scheduling module is specifically configured for the UE performing measurement on the beam at the second beam level.

In an example embodiment, if the scheduled beam is the beam at the first beam level, when a serving beam for the UE is the beam at the second beam level, the apparatus further includes a cross-level beam scheduling module configured to:
determine, based on remaining resources of the scheduled beam and/or the information on transmission capacity of the UE, whether to adjust the serving beam for the UE to the scheduled beam.

In an example embodiment,
the attribute of the beam comprises the number of beams and/or a beam width; and/or
beams at different beam levels have different widths, and the beam width of the first beam level is greater than the beam width of the second beam level; and/or
the base station corresponds to at least one second beam level.

In an example embodiment, the information on transmission capacity includes an average synchronization signal reference signal received power (SS-RSRP); and/or
the mobility information comprises a beam change frequency (BCF).

In an example embodiment, the measurement determination module further includes:
a beam level determination sub-module configured to determine, based on at least one of information on transmission capacity, mobility information and traffic information of the UE, the beam level corresponding to the UE;
a measurement indication sub-module configured to instruct the UE to perform a beam measurement at a second beam level if the determined beam level corresponding to the UE is the second beam level.

In an example embodiment, if the UE is currently in the first beam level, the beam level determination sub-module is configured to:
determine, based on the information on transmission capacity and/or the mobility information of the UE, an adjusted beam level corresponding to the UE; and
determine, based on the traffic of the UE to be transmitted, whether to adjust the beam level for the UE to the adjusted beam level.

In an example embodiment, the beam level determination sub-module is further configured to:
if the traffic of the UE to be transmitted is not zero, adjust the beam level for the UE to the adjusted beam level; and
if the traffic of the UE to be transmitted is zero, keep the beam level for the UE constant at the first beam level and save the adjusted beam level.

In an example embodiment, if the UE is currently in the second beam level, the beam level determination sub-module is configured to:
determine, based on at least one of the traffic of the UE to be transmitted within a preset number of consecutive slots, the information on transmission capacity and the mobility information of the UE, whether to adjust the beam level for the UE to the first beam level.

In an example embodiment, the beam level determination sub-module is further configured to:
if the traffic of the UE to be transmitted is zero within a preset number of consecutive slots, adjust the beam level for the UE to the first beam level and save the beam level for the UE before the adjustment;
if the information on transmission capacity of the UE indicates that the transmission capacity of the UE meets a first preset condition, adjust the beam level for the UE to the first beam level; and
if the mobility information of the UE indicates that the mobility of the UE meets a second preset condition, adjust the beam level for the UE to the first beam level.

In an example embodiment, the beam level determination sub-module is further configured to:
if the traffic of the UE changes from zero to non-zero, adjust the beam level for the UE to the corresponding second beam level; and
wherein, the corresponding second beam level is the last saved beam level.

In an example embodiment, if the UE is currently in the second beam level, the beam level determination sub-module is configured to:
determine, based on at least one of the information on transmission capacity and the mobility information of the UE, whether to adjust the beam level for the UE to other second beam level.

In an example embodiment, the beam level determination sub-module is further configured to:
if the information on transmission capacity of the UE indicates that the transmission capacity of the UE meets a third preset condition and the mobility information of the UE indicates that the mobility of the UE meets a fourth preset condition, adjust the beam level for the UE to the other second beam level.

In an example embodiment, the apparatus further includes a beam attribute determination module configured to:
obtain, using a prediction model, a predicted traffic of each beam coverage area of the first beam level, based on the historical traffic of each beam coverage area in the first beam level; and
determine, based on the predicted traffic of each beam coverage area of the first beam level, the attribute of the beam at the second beam level respectively corresponding to each beam at the first beam level.

In an example embodiment, the apparatus further includes a beam predicted traffic adjustment module configured to:
obtain historical information on transmission capacity of each beam at the first beam level; and
adjust the predicted traffic of each beam coverage area of the first beam level based on the historical information on transmission capacity of each beam at the first beam level.

In an example embodiment, wherein, the attribute of beam includes the number of beams and/or a beam width, the number of beams includes the number of vertical beams and the number of horizontal beams, and the beam width comprises a vertical beam width and a horizontal beam width;
the beam attribute determination module is specifically configured to:
obtain, based on the predicted traffic of each beam coverage area of the first beam level, the number of vertical beams and the number of horizontal beams at the second beam level respectively corresponding to each beam at the first beam level; and
obtain, based on the number of vertical beams and the number of horizontal beams at the second beam level, the vertical beam width and the horizontal beam width of each beam at the second beam level.

In an example embodiment, the beam attribute determination module is further configured to:
obtain, based on the predicted traffic of each beam coverage area of the first beam level, the traffic proportion of each beam coverage area of the first beam level in the overall traffic of a cell; and
obtain, based on the traffic proportion corresponding to each beam coverage area at the first beam level, the number of vertical beams and the number of horizontal beams at the second beam level corresponding to each beam at the first beam level.

In an example embodiment, the beam attribute determination module is further configured to:
obtain, based on the traffic proportion corresponding to each beam coverage area at the first beam level, the total number of beams in horizontal dimension at the corresponding second beam level, and the total number of beams in vertical dimension at the corresponding second beam level, an initial number of vertical beams and an initial number of horizontal beams at the second beam level corresponding to each beam at the first beam level; and
obtain, based on the initial number of vertical beams and the initial number of horizontal beams at the second beam level corresponding to each beam at the first beam level, the number of vertical beams and the number of horizontal beams at the second beam level.

In an example embodiment, the beam attribute determination module is further configured to:
if the sum of number of beams of each beam at the second beam level corresponding to each beam at the first beam level is equal to the maximum number of beams allowed in the second beam level, regard the initial number of vertical beams and the initial number of horizontal beams of the second beam level as the number of vertical beams and the number of horizontal beams at the second beam level respectively; and
if the sum of number of beams of each beam at the second beam level corresponding to each beam at the first beam level is not equal to the maximum number of beams allowed in the second beam level, obtain the number of vertical beams and the number of horizontal beams at the second beam level by adjusting the initial number of vertical beams and/or the initial number of horizontal beams of the second beam level corresponding each beam at the first beam level until the sum of number of beams of each beam at the second beam level corresponding to each beam at the first beam level is equal to the maximum number of beams allowed in the second beam level.

In an example embodiment, the beam attribute determination module is further configured to:
obtain, based on the number of vertical beams at the second beam level, the number of vertical beams at the first beam level, and a coverage width in a vertical dimension in a cell, the vertical beam width of the second beam level; and
obtain, based on the number of horizontal beams at the second beam level, the number of horizontal beams at the first beam level, and a coverage width in a horizontal dimension in a cell, the horizontal beam width of the second beam level.

In an example embodiment, wherein, the attribute of beam includes the number of beams and/or a beam width;
the apparatus further includes a beam determination module configured to:
select, from a preset beam set, at least one candidate beam, based on the beam width of each beam at the second beam level; and
obtain a correlation factor between each candidate beam and the beam of first beam level, and determine the beam at the second beam level based on the correlation factor and the number of beams of each beam at the second beam level.

In an example embodiment, the beam determination module is configured to:
select, from the preset beam set, at least one beam with the same beam width as the second beam level or a beam width in a preset range, as the candidate beam.

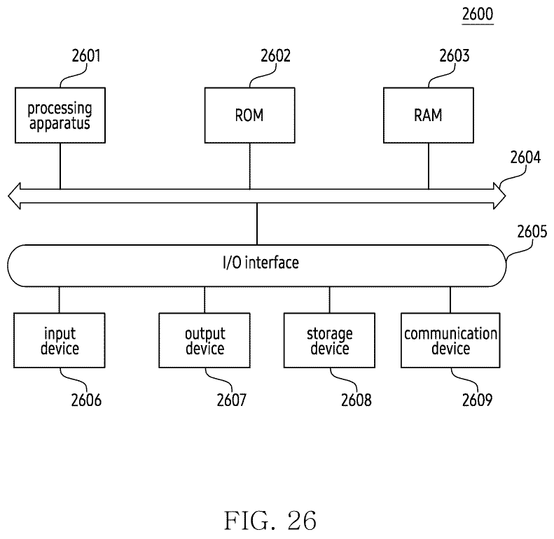

Referring to FIG. 26, which is a diagram illustrating an example configuration of an electronic device 2600 (for example, the base station that executes the method shown in FIG. 5) according to various embodiments. The electronic devices in the various embodiments may include, but are not limited to, mobile terminals (such as mobile phones, notebook computers, digital broadcast receivers, PDAs (personal digital assistants), PADs (tablet computers), PMPs (portable multimedia players), vehicle-mounted terminals (for example, car navigation terminals)) and fixed terminals (such as digital TVs, desktop computers, etc.). The electronic device shown in FIG. 26 is only an example, and should not bring any limitation to the functions and scope of use of the various embodiments.

The electronic device includes: a memory and a processor, wherein the memory is configured to store programs for executing the methods described in the foregoing method embodiments; and the processor is configured to execute the programs stored in the memory. Wherein, the processor may include various processing circuitry an may be referred to as the processing device 2601 described below, and the memory may include at least one of a read-only memory (ROM) 2602, a random-access memory (RAM) 2603, and a storage device 2608, shown as follows:

As shown in FIG. 26, the electronic device 2600 may include a processing device (such as a central processing unit, a graphics processor, etc.) 2601, which can execute various appropriate actions and processing according to programs stored in a read-only memory (ROM) 2602 or programs loaded from a storage device 2608 into a random-access memory (RAM) 2603. In RAM 2603, various programs and data required for the operation of the electronic device 2600 are also stored. The processing device 2601, ROM 2602, and RAM 2603 are connected to each other through a bus 2604. An input/output (I/O) interface (e.g., including interface circuitry) 2605 is also connected to the bus 2604.

Generally, the following devices can be connected to the I/O interface 2605: an input device (e.g., including input circuitry) 2606 such as touch screen, touch pad, keyboard, mouse, camera, microphone, accelerometer, gyroscope, etc.; an output device (e.g., including output circuitry) 2607 such as liquid crystal display (LCD), speaker, vibration; a storage device 2608 such as a magnetic tape, a hard disk, etc.; and a communication device (e.g., including communication circuitry) 2609. The communication device 2609 may allow the electronic device 2600 to perform wireless or wired communication with other devices to exchange data. Although FIG. 26 shows an electronic device having various devices, it should be understood that it is not required to implement or have all the illustrated devices. It may alternatively be implemented or provided with more or fewer devices.

For example, according to various embodiments, the process described above with reference to the flowchart can be implemented as computer software programs. For example, various embodiments include a computer program product, which includes computer programs carried on a non-transitory computer readable medium, and the computer programs include program codes for executing the method shown in the flowchart. In such an embodiment, the computer programs may be downloaded and installed from the network through the communication device 2609, or installed from the storage device 2608, or installed from the ROM 2602. When the computer programs are executed by the processing device 2601, it executes the above functions defined in the method of various embodiments.

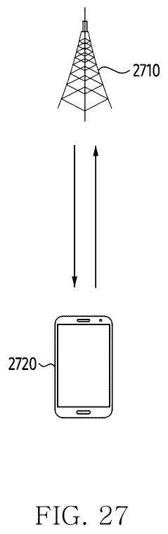

FIG. 27 is a diagram illustrating an example of a wireless communication system according to various embodiments.

Referring to FIG. 27, it illustrates a base station 2710 and a terminal 2720 as parts of nodes using a wireless channel in a wireless communication system. Although FIG. 27 illustrates only one base station, the wireless communication system may further include another base station that is the same as or similar to the base station 2710.

The base station 2710 is a network infrastructure that provides wireless access to the terminal 2720. The base station 2710 may have a coverage defined based on a distance capable of transmitting a signal. In addition to the term ‘base station’, the base station 2710 may be referred to as ‘access point (AP), ‘eNodeB (eNB)’, ‘5th generation node’, ‘next generation nodeB (gNB)’, ‘wireless point’, ‘transmission/reception’, or other terms having the same or equivalent meaning thereto.

The terminal 2720, which is a device used by a user, performs communications with the base station 2710 through a wireless channel. A link from the base station 2710 to the terminal 2720 is referred to as a downlink (DL), and a link from the terminal 2720 to the base station 2710 is referred to as an uplink (UL). Further, although not shown in FIG. 27, the terminal 2720 and other terminals may perform communications with each other through the wireless channel In this context, a link between the terminal 2720 and another terminals (device-to-device link, D2D) is referred to as a side link, and the side link may be used mixed with a PC5 interface. In some other embodiments of the disclosure, the terminal 2720 may be operated without any user's involvement. According to an embodiment of the disclosure, the terminal 2720 is a device that performs machine-type communication (MTC) and may not be carried by a user. In addition, according to an embodiment of the disclosure, the terminal 2720 may be a narrowband (NB)-Internet of things (IoT) device.

The terminal 2720 may be referred to as ‘user equipment (UE), ‘customer premises equipment (CPE), ‘mobile station’, ‘subscriber station’, ‘remote terminal’, ‘wireless terminal’, ‘electronic device’, ‘user device’, or any other term having the same or equivalent technical meaning thereto.

The base station 2710 may perform beamforming with the terminal 2720. The base station 2710 and the terminal 2720 may transmit and receive radio signals in a relatively low frequency band (e.g., FR 1 (frequency range 1) of NR). Further, the base station 2710 and the terminal 2720 may transmit and receive radio signals in a relatively high frequency band (e.g., FR 2 of NR (or FR 2-1, FR 2-2, FR 2-3), FR 3, or millimeter wave (mmWave) bands (e.g., 28 GHz, 30 GHz, 38 GHz, 60 GHz)). In order to improve the channel gain, the base station 2710 and the terminal 2720 may perform beamforming. In this context, the beamforming may include transmission beamforming and reception beamforming. The base station 2710 and the terminal 2720 may assign directionality to a transmission signal or a reception signal. To that end, the base station 2710 and the terminal 2720 may select serving beams through a beam search or beam management procedure. After the serving beams are selected, subsequent communication may be performed through a resource having a quasi-co located (QCL) relationship with a resource that has transmitted the serving beams.

A first antenna port and a second antenna port may be evaluated to be in such a QCL relationship, if the wide-scale characteristics of a channel carrying symbols on the first antenna port can be estimated from a channel carrying symbols on the second antenna port. For example, the wide-scale characteristics may include at least one of delay spread, Doppler spread, Doppler shift, average gain, average delay, and spatial receiver parameters.

Although in FIG. 27, both the base station 2710 and the terminal 2720 are described as performing beamforming, embodiments of the disclosure are not necessarily limited thereto. In some embodiments of the disclosure, the terminal may or may not perform beamforming. Likewise, the base station may or may not perform beamforming. That is to say, only either one of the base station and the terminal may perform beamforming, or both the base station and the terminal may not perform beamforming.

In the disclosure, a beam means a spatial flow of a signal in a radio channel, and may be formed by one or more antennas (or antenna elements), of which formation process may be referred to as beamforming. The beamforming may include at least one of analog beamforming and digital beamforming (e.g., precoding). Reference signals transmitted based on beamforming may include, for example, a demodulation-reference signal (DM-RS), a channel state information-reference signal (CSI-RS), a synchronization signal/physical broadcast channel (SS/PBCH), or a sounding reference signal (SRS). Further, for a configuration for each reference signal, an IE, such as a CSI-RS resource, an SRS-resource, or the like may be used, and the configuration may include information associated with a beam. Beam-associated information may refer to whether a corresponding configuration (e.g., CSI-RS resource) uses the same spatial domain filter as other configuration (e.g., another CSI-RS resource within the same CSI-RS resource set) or uses a different spatial domain filter, or with which reference signal is QCL, or if QCLed, what type (e.g., QCL type A, B, C, or D) it has.

According to the related art, in a communication system with a relatively large cell radius of a base station, each base station was installed so that the respective base station includes functions of a digital processing unit (or distributed unit (DU)) and a radio frequency (RF) processing unit (or radio unit (RU)). However, as high-frequency bands are used in 4th generation (4G) systems and/or its subsequent communication systems (e.g., fifth-generation (5G), and the cell coverage of a base station decreased, the number of base stations to cover a certain area has increased. Thus, it led to more increased burden of initial installation costs for communication providers to install more base stations. In order to reduce the installation costs of the base station, a structure has been proposed in which the DU and the RU of the base station are separated so that one or more RUs are connected to one DU through a wired network and one or more RUs geographically distributed are arranged to cover a specific area.

For example, a method performed by a base station, comprises transmitting, to a user equipment (UE) a first signal for performing a beam measurement at a first beam level, identifying, based on at least one of information on transmission capacity, mobility information or traffic information of the UE received from the UE, whether to transmit, to the UE, a second signal for performing a beam measurement at a second beam level; and receiving, based on at least one of the first signal or the second signal, beam measurement results of the UE and performing beam scheduling. A scheduled beam identified by the beam scheduling includes a beam at the first beam level or a beam at the second beam level. Serving cells of the base station are covered by each of the beam levels. Attribute information of a first beam according to the first beam level is distinct from attribute information of a second beam according to the second beam level. Based on the scheduled beam being the beam at the first beam level, the UE served by the scheduled beam comprises the UE performing measurement on the beam at the second beam level.

For example, the method comprises, based on the scheduled beam being the beam at the first beam level and a serving beam for the UE being the beam at the second beam level, identifying, based on at least one of remaining resources of the scheduled beam or the information on transmission capacity of the UE, whether to adjust the serving beam for the UE to the scheduled beam.

For example, the attribute information of beams including the first beam and second beam comprises at least one of a number of beams or a beam width. wherein beams at different beam levels have different widths. A beam width of the first beam level is greater than a beam width of the second beam level.

For example, the information on transmission capacity comprises an average synchronization signal reference signal received power (SS-RSRP). The mobility information comprises a beam change frequency (BCF).

For example, identifying, based on at least one of information on transmission capacity, mobility information or traffic information of the UE, whether to transmit, to the UE, the second signal for performing the beam measurement at a second beam level, comprises identifying a beam level related to the UE based on at least one of the information on transmission capacity, the mobility information or the traffic information of the UE, and transmit, to the UE, the second signal for performing the beam measurement at the second beam level, based on the identified beam level related to the UE being the second beam level.

For example, the method comprises identifying, based on at least one of the information on transmission capacity or the mobility information of the UE, an adjusted beam level related to the UE, and identifying, based on the traffic of the UE to be transmitted, whether to adjust the beam level for the UE from the first beam level to the adjusted beam level.

For example, identifying whether to adjust the beam level for the UE from the first beam level to the adjusted beam level, comprises based on the traffic of the UE to be transmitted not being existed, adjusting the beam level for the UE from the first beam level to the adjusted beam level and based on the traffic of the UE to be transmitted being existed, maintaining the beam level for the UE as the first beam level and saving the adjusted beam level.

For example, the method comprises identifying, based on at least one of the traffic of the UE to be transmitted within a specified number of consecutive slots, the information on transmission capacity or the mobility information of the UE, whether to adjust the beam level for the UE to the first beam level.

For example, identifying whether to adjust the beam level for the UE to the first beam level, comprises: based on the traffic of the UE to be transmitted being existed within a specified number of consecutive slots, adjusting the beam level for the UE to the first beam level and saving the beam level for the UE before the adjustment; based on the information on transmission capacity of the UE indicating that the transmission capacity of the UE meets a first specified condition, adjusting the beam level for the UE to the first beam level; and based on the mobility information of the UE indicating that the mobility of the UE meets a second specified condition, adjusting the beam level for the UE to the first beam level.

For example, the method comprises: based on the traffic of the UE being generated from a state that the traffic is not existed, adjusting the beam level for the UE to the corresponding second beam level. The corresponding second beam level is the last saved beam level.

For example, based on the UE being operated in the second beam level, identifying the beam level corresponding to the UE, comprises: identifying, based on at least one of the information on transmission capacity or the mobility information of the UE, whether to adjust the beam level for the UE to another second beam level.

For example, identifying whether to adjust the beam level for the UE to the another second beam level, comprises: based on the information on transmission capacity of the UE indicating that the transmission capacity of the UE meets a third specified condition and the mobility information of the UE indicating that the mobility of the UE meets a fourth specified condition, adjusting the beam level for the UE to the another second beam level.

For example, the method comprises: obtaining, using a specified model, a predicted traffic of each beam coverage area of the first beam level, based on a historical traffic of each beam coverage area in the first beam level; and identifying, based on the predicted traffic of each beam coverage area of the first beam level, the attribute information of the second beam according to the second beam level.

For example, the method comprises: obtaining historical information on transmission capacity of each beam at the first beam level; and adjusting the predicted traffic of each beam coverage area of the first beam level based on the historical information on transmission capacity of each beam at the first beam level.

For example, the method comprises identifying attribute information of beams including the first beam and the second beam. The attribute information of the beams comprises information on the number of the beams and information on beam widths of the beams. The information on the number of the beams comprises the number of vertical beams and the number of horizontal beams. The information on beam widths of the beams comprises beam widths of the vertical beams and beam widths of the horizontal beams.

For example, the method comprises: obtaining, based on the number of vertical beams at the second beam level, the number of vertical beams at the first beam level, and a coverage width in a vertical dimension in a cell, information on vertical beam widths of the second beam level; and obtaining, based on the number of horizontal beams at the second beam level, the number of horizontal beams at the first beam level, and a coverage width in a horizontal dimension in a cell, information on horizontal beam widths of the second beam level.

For example, the method comprises after transmitting a signal to the UE through the first beam according to the first beam level at a first slot followed by a second slot, transmitting another signal to another UE through the second beam according to the second beam at the second slot. A beam width of the second beam is narrower than a beam width of the first beam.

For example, a base station, comprises a memory and a processor. The memory has computer programs stored therein. The processor is configured to execute the computer programs to: transmit, to a user equipment (UE) a first signal for performing a beam measurement at a first beam level; identify, based on at least one of information on transmission capacity, mobility information or traffic information of the UE received from the UE, whether to transmit, to the UE, a second signal for performing a beam measurement at a second beam level; and receive, based on at least one of the first signal or the second signal, beam measurement results of the UE and performing beam scheduling. A scheduled beam identified by the beam scheduling includes a beam at the first beam level or a beam at the second beam level. Serving cells of the base station are covered by each of the beam levels. Attribute information of a first beam according to the first beam level is distinct from attribute information of a second beam according to the second beam level.

For example, a non-transitory computer readable storage medium stores one or more programs. The one or more programs includes instructions, which, when being executed by at least one processor of a base station cause the base station to: transmit, to a user equipment (UE) a first signal for performing a beam measurement at a first beam level; identify, based on at least one of information on transmission capacity, mobility information or traffic information of the UE received from the UE, whether to transmit, to the UE, a second signal for performing a beam measurement at a second beam level; and receive, based on at least one of the first signal or the second signal, beam measurement results of the UE and performing beam scheduling. A scheduled beam identified by the beam scheduling includes a beam at the first beam level or a beam at the second beam level. Serving cells of the base station are covered by each of the beam levels. Attribute information of a first beam according to the first beam level is distinct from attribute information of a second beam according to the second beam level.

For example, a method performed by a base station, comprises: instructing a user equipment (UE) to perform a beam measurement at a first beam level; determining, based on at least one of information on transmission capacity, mobility information and traffic information of the UE, whether to instruct the UE to perform a beam measurement at a second beam level; and receiving beam measurement results of the UE and performing beam scheduling. The scheduled beam includes a beam at the first beam level or a beam at the second beam level. Serving cells of the base station are covered by each of the beam levels, and beams at different beam levels have different attributes.

For example, based on the scheduled beam being the beam at the first beam level, the UE served by the scheduled beam comprises the UE performing measurement on the beam at the second beam level.

For example, the method comprises based on the scheduled beam being the beam at the first beam level, based on a serving beam for the UE being the beam at the second beam level, determining, based on remaining resources of the scheduled beam and/or the information on transmission capacity of the UE, whether to adjust the serving beam for the UE to the scheduled beam.

For example, the attribute of the beam comprises a number of beams and/or a beam width. beams at different beam levels have different widths. A beam width of the first beam level is greater than a beam width of the second beam level. The base station corresponds to at least one second beam level.

For example, the information on transmission capacity comprises an average synchronization signal reference signal received power (SS-RSRP). A mobility information comprises a beam change frequency (BCF).

For example, determining, based on at least one of information on transmission capacity, mobility information and traffic information of the UE, whether to instruct the UE to perform a beam measurement at a second beam level, comprises: determining a beam level corresponding to the UE based on at least one of the information on transmission capacity, the mobility information and the traffic information of the UE; and instructing the UE to perform the beam measurement at the second beam level, based on the determined beam level corresponding to the UE being the second beam level.

For example, based on the UE currently being in the first beam level, determining the beam level corresponding to the UE, comprises: determining, based on the information on transmission capacity and/or the mobility information of the UE, an adjusted beam level corresponding to the UE; and determining, based on the traffic of the UE to be transmitted, whether to adjust the beam level for the UE to the adjusted beam level.

For example, determining whether to adjust the beam level for the UE to the adjusted beam level, comprises: based on the traffic of the UE to be transmitted not being zero, adjusting the beam level for the UE to the adjusted beam level; and based on the traffic of the UE to be transmitted being zero, keeping the beam level for the UE constant at the first beam level and saving the adjusted beam level.

For example, based on the UE currently being in the second beam level, determining the beam level corresponding to the UE, comprises: determining, based on at least one of the traffic of the UE to be transmitted within a specified number of consecutive slots, the information on transmission capacity and the mobility information of the UE, whether to adjust the beam level for the UE to the first beam level.

For example, determining whether to adjust the beam level for the UE to the first beam level, comprises: based on the traffic of the UE to be transmitted being zero within a specified number of consecutive slots, adjusting the beam level for the UE to the first beam level and saving the beam level for the UE before the adjustment; based on the information on transmission capacity of the UE indicating that the transmission capacity of the UE meets a first specified condition, adjusting the beam level for the UE to the first beam level; and based on the mobility information of the UE indicating that the mobility of the UE meets a second specified condition, adjusting the beam level for the UE to the first beam level.

For example, the method comprises based on the traffic of the UE changing from zero to non-zero, adjusting the beam level for the UE to the corresponding second beam level. The corresponding second beam level is the last saved beam level.

For example, based on the UE currently being in the second beam level, determining the beam level corresponding to the UE, comprises: determining, based on at least one of the information on transmission capacity and the mobility information of the UE, whether to adjust the beam level for the UE to another second beam level.

For example, determining whether to adjust the beam level for the UE to another second beam level, comprises: based on the information on transmission capacity of the UE indicating that the transmission capacity of the UE meets a third specified condition and the mobility information of the UE indicating that the mobility of the UE meets a fourth specified condition, adjusting the beam level for the UE to the another second beam level.

For example, the method comprises: obtaining, using a prediction model, a predicted traffic of each beam coverage area of the first beam level, based on a historical traffic of each beam coverage area in the first beam level; and determining, based on the predicted traffic of each beam coverage area of the first beam level, the attribute of beam at the second beam level respectively corresponding to each beam at the first beam level.

For example, the method comprises: obtaining historical information on transmission capacity of each beam at the first beam level; and adjusting the predicted traffic of each beam coverage area of the first beam level based on the historical information on transmission capacity of each beam at the first beam level.

For example, the attribute of beam comprises a number of beams and/or a beam width, the number of beams comprises the number of vertical beams and the number of horizontal beams, and the beam width comprises a vertical beam width and a horizontal beam width. For example, determining, based on the predicted traffic of each beam coverage area of the first beam level, the attribute of the beam at the second beam level respectively corresponding to each beam at the first beam level, comprises: obtaining, based on the predicted traffic of each beam coverage area of the first beam level, the number of vertical beams and the number of horizontal beams at the second beam level respectively corresponding to each beam at the first beam level; and obtaining, based on the number of vertical beams and the number of horizontal beams at the second beam level, the vertical beam width and the horizontal beam width of each beam at the second beam level.

For example, obtaining, based on the predicted traffic of each beam coverage area of the first beam level, the number of vertical beams and the number of horizontal beams at the second beam level respectively corresponding to each beam at the first beam level, comprises: obtaining, based on the predicted traffic of each beam coverage area of the first beam level, the traffic proportion of each beam coverage area of the first beam level in the overall traffic of a cell; and obtaining, based on the traffic proportion corresponding to each beam coverage area at the first beam level, the number of vertical beams and the number of horizontal beams at the second beam level corresponding to each beam at the first beam level.

For example, obtaining, based on the traffic proportion corresponding to each beam coverage area at the first beam level, the number of vertical beams and the number of horizontal beams at the second beam level corresponding to each beam at the first beam level, comprises: obtaining, based on the traffic proportion corresponding to each beam coverage area at the first beam level, the total number of beams in horizontal dimension at the corresponding second beam level, and the total number of beams in vertical dimension at the corresponding second beam level, an initial number of vertical beams and an initial number of horizontal beams at the second beam level corresponding to each beam at the first beam level; and obtaining, based on the initial number of vertical beams and the initial number of horizontal beams at the second beam level corresponding to each beam at the first beam level, the number of vertical beams and the number of horizontal beams at the second beam level.

For example, obtaining, based on the initial number of vertical beams and the initial number of horizontal beams at the second beam level corresponding to each beam at the first beam level, the number of vertical beams and the number of horizontal beams of the second beam level, comprises: based on the sum of number of beams of each beam at the second beam level corresponding to each beam at the first beam level being equal to the maximum number of beams allowed in the second beam level, regarding the initial number of vertical beams and the initial number of horizontal beams of the second beam level as the number of vertical beams and the number of horizontal beams at the second beam level respectively; and based on the sum of number of beams of each beam at the second beam level corresponding to each beam at the first beam level not being equal to the maximum number of beams allowed in the second beam level, obtaining the number of vertical beams and the number of horizontal beams at the second beam level by adjusting the initial number of vertical beams and/or the initial number of horizontal beams of the second beam level corresponding each beam at the first beam level until the sum of number of beams of each beam at the second beam level corresponding to each beam at the first beam level is equal to the maximum number of beams allowed in the second beam level.

For example, obtaining, based on the number of vertical beams and the number of horizontal beams at the second beam level, the vertical beam width and the horizontal beam width of each beam at the second beam level, comprises: obtaining, based on the number of vertical beams at the second beam level, the number of vertical beams at the first beam level, and a coverage width in a vertical dimension in a cell, the vertical beam width of the second beam level; and obtaining, based on the number of horizontal beams at the second beam level, the number of horizontal beams at the first beam level, and a coverage width in a horizontal dimension in a cell, the horizontal beam width of the second beam level.

For example, the attribute of beam comprises the number of beams and the beam width. The method comprises: selecting, from a specified beam set, at least one candidate beam, based on the beam width of each beam at the second beam level; and obtaining a correlation factor between each candidate beam and the beam of first beam level, and determining the beam at the second beam level based on the correlation factor and the number of beams of each beam at the second beam level.

For example, selecting, from a specified beam set, at least one candidate beam, based on the beam width of each beam at the second beam level, comprises: selecting, from the specified beam set, at least one beam with a same beam width as the second beam level or a beam width in a specified range, as the candidate beam.

For example, determining the beam at the second beam level based on the correlation factor and the number of beams of each beam at the second beam level, comprises: arranging each candidate beam in a descending order according to the value of the corresponding correlation factor, and determining the candidate beam with the number of beams ranked first as the beam at the second beam level.

For example, a base station, comprises a memory and a processor. The memory has computer programs stored therein. The processor is configured to execute the computer programs to instruct a user equipment (UE) to perform a beam measurement at a first beam level; determine, based on at least one of information on transmission capacity, mobility information and traffic information of the UE, whether to instruct the UE to perform a beam measurement at a second beam level; and receive beam measurement results of the UE and performing beam scheduling. The scheduled beam includes a beam at the first beam level or a beam at the second beam level. Serving cells of the base station are covered by each of the beam levels, and beams at different beam levels have different attributes.

For example, a non-transitory computer readable storage medium has computer programs stored thereon. The computer programs, when executed by a processor, perform instructing a user equipment (UE) to perform a beam measurement at a first beam level; determining, based on at least one of information on transmission capacity, mobility information and traffic information of the UE, whether to instruct the UE to perform a beam measurement at a second beam level; and receiving beam measurement results of the UE and performing beam scheduling. The scheduled beam includes a beam at the first beam level or a beam at the second beam level. Serving cells of the base station are covered by each of the beam levels, and beams at different beam levels have different attributes.

It should be noted that the aforementioned computer readable medium may be a computer readable signal medium or a computer readable storage medium, or any combination of the two. The computer readable storage medium may be, for example, but not limited to, an electric, magnetic, optical, electromagnetic, infrared, or semiconductor system, apparatus, or device, or any combination of the above. More specific examples of computer readable storage medium may include, but are not limited to: electrical connections with one or more wires, portable computer disks, hard disks, random access memory (RAM), read-only memory (ROM), erasable programmable read only memory (EPROM or flash memory), optical fiber, portable compact disk read only memory (CD-ROM), optical storage device, magnetic storage device, or any suitable combination of the above. In the disclosure, a computer readable storage medium may be any tangible medium that contains or stores a program, and the program may be used by or in combination with an instruction execution system, apparatus, or device. In the present disclosure, a computer readable signal medium may include a data signal propagated in a baseband or as a part of a carrier wave, and a computer readable program codes are carried therein. This propagated data signal can take many forms, including but not limited to electromagnetic signals, optical signals, or any suitable combination of the foregoing. The computer readable signal medium may also be any computer readable medium other than the computer readable storage medium. The computer readable signal medium may send, propagate, or transmit the program for use by or in combination with the instruction execution system, apparatus, or device. The program codes contained on the computer readable medium can be transmitted by any suitable medium, including but not limited to: wire, optical cable, RF (radio frequency), etc., or any suitable combination of the above.

In various embodiments, the client and server can communicate with any currently known or future-developed network protocol such as HTTP (HyperText Transfer Protocol), and can be interconnected with any form or medium of digital data communication (for example, communication network). Examples of communication networks include local area networks (“LAN”), wide area networks (“WAN”), the Internet (for example, the Internet), and end-to-end networks (for example, ad hoc end-to-end networks), as well as any currently known or future-developed network.

The above computer readable mediums may be contained in the above electronic device; or it may exist alone without being assembled into the electronic device.

The above computer readable medium carries one or more programs, and when the above one or more programs are executed by the electronic device, causing the electronic device to:
instruct a user equipment (UE) to perform a beam measurement at a first beam level; determine, based on at least one of information on transmission capacity, mobility information and traffic information of the UE, whether to instruct the UE to perform a beam measurement at a second beam level; and receive beam measurement results of the UE and perform beam scheduling, and wherein, a scheduled beam is a beam at the first beam level or a beam at the second beam level; serving cells of the base station are covered by each of the beam levels, and beams at different beam levels have different attributes.

The computer program codes for performing the operations may be written in one or more programming languages, or combinations thereof. The programming languages include, but be not limited to object-oriented programming languages, such as Java, Smalltalk, and C++, and conventional procedural programming languages, such as “C” or similar programming languages. The program codes can be executed entirely on the user's computer, partly on the user's computer, executed as an independent software package, partly on the user's computer and partly executed on a remote computer, or entirely executed on the remote computer or server. In the case of a remote computer, a remote computer can be connected to the user's computer through any kind of network, including a local area network (LAN) or a wide area network (WAN), or it can be connected to an external computer (for example, using an Internet service provider to pass Internet connection).

The flowcharts and block diagrams in the accompanying drawings illustrate the possible implementation architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for realizing the specified logical function. It should also be noted that, in some alternative implementations, the functions marked in the block may also occur in a different order from the order marked in the drawings. For example, two blocks shown in succession can actually be executed substantially in parallel, or they can sometimes be executed in the reverse order, depending on the functions involved. It should also be noted that each block in the block diagram and/or flowchart, and a combination of blocks in the block diagram and/or flowchart, can be implemented by a dedicated hardware-based system that performs the specified function or operation, or it can be realized by a combination of dedicated hardware and computer instructions.

The modules or units involved in the embodiments described herein can be implemented in software or hardware or any combination thereof. Wherein, the name of the module or unit does not constitute a limitation on the unit itself under certain circumstances. For example, the first position information acquisition module can also be described as “a module for acquiring first position information”.

The above functions herein may be performed at least in part by one or more hardware logic components. For example, without limitation, example types of hardware logic components that can be used include: Field Programmable Gate Array (FPGA), Application Specific Integrated Circuit (ASIC), Application Specific Standard Product (ASSP), System on Chip (SOC), Complex Programmable Logical device (CPLD) and the like.

In the context of the disclosure, a machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the foregoing. More specific examples of machine-readable storage media would include electrical connections based on one or more wires, portable computer disks, hard drives, random access memory (RAM), read-only memory (ROM), erasable programmable read-only memory (EPROM or flash memory), optical fiber, portable compact disk read only memory (CD-ROM), optical storage device, magnetic storage device, or any suitable combination of the above.

The device provided in an embodiment may implement at least one of the multiple modules through an AI model. The AI-associated functions can be executed by a non-volatile memory, a volatile memory and a processor.

The processor may include one or more processors. At this time, the one or more processors may be general-purpose processors (e.g., central processing units (CPUs), application processors (APs), etc.), or pure graphics processing units (e.g., a graphics processing units (GPUs), visual processing units (VPUs)), and/or AI-specific processors (e.g., neural processing units (NPUs)).

The one or more processors control the processing of input data according to predefined operating rules or artificial intelligence (AI) models stored in non-volatile memory and volatile memory. Predefined operating rules or artificial intelligence models are provided through training or learning.

Here, providing by learning may refer, for example, to the predefined operation rule or AI model with desired characteristics being obtained by applying a learning algorithm to multiple pieces of learning data. The learning may be executed in an apparatus in which the AI according to the embodiments is executed, and/or may be implemented by a separate server/system.

The AI model may contain multiple neural network layers. Each layer has a plurality of weights, and the calculation in one layer is executed using the result of calculation in the previous layer and a plurality of weights of the current layer. Examples of neural networks include, but are not limited to, convolutional neural networks (CNN), deep neural networks (DNN), recurrent neural networks (RNN), restricted boltzmann machines (RBM), deep belief networks (DBN), bidirectional recurrent deep neural networks (BRDNN), generative adversarial networks (GAN), and Deep Q-Networks.

A learning algorithm is a method of training a predetermined target device (e.g., a robot) using a plurality of learning data to cause, allow or control the target device to make determinations or predictions. Examples of the learning algorithm include, but are not limited to, supervised learning, unsupervised learning, semi-supervised learning, or reinforcement learning.

Those skilled in the art can clearly understand that for the convenience and conciseness of the description, the specific method implemented when the computer readable medium described above is executed by an electronic device can refer to the corresponding process in the foregoing embodiments, which will not be repeated here.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

What is claimed is:

1. A method performed by a base station, comprising:
transmitting, to a user equipment (UE) a first signal for performing a beam measurement at a first beam level;
identifying, based on at least one of information on transmission capacity, mobility information or traffic information of the UE received from the UE, whether to transmit, to the UE, a second signal for performing a beam measurement at a second beam level; and
receiving, based on at least one of the first signal or the second signal, beam measurement results of the UE and performing beam scheduling,
wherein, a scheduled beam identified by the beam scheduling includes a beam at the first beam level or a beam at the second beam level,
wherein serving cells of the base station are covered by each of the beam levels, and
wherein attribute information of a first beam according to the first beam level is distinct from attribute information of a second beam according to the second beam level.

2. The method according to claim 1, wherein, based on the scheduled beam being the beam at the first beam level, the UE served by the scheduled beam comprises the UE performing measurement on the beam at the second beam level.

3. The method according to claim 1, further comprising:
based on the scheduled beam being the beam at the first beam level and a serving beam for the UE being the beam at the second beam level, identifying, based on at least one of remaining resources of the scheduled beam or the information on transmission capacity of the UE, whether to adjust the serving beam for the UE to the scheduled beam.

4. The method according to claim 1, wherein, the attribute information of beams including the first beam and second beam comprises at least one of a number of beams or a beam width,
wherein beams at different beam levels have different widths, and
wherein a beam width of the first beam level is greater than a beam width of the second beam level.

5. The method according to claim 1, wherein the information on transmission capacity comprises an average synchronization signal reference signal received power (SS-RSRP), and
wherein the mobility information comprises a beam change frequency (BCF).

6. The method according to claim 1, wherein, identifying, based on at least one of information on transmission capacity, mobility information or traffic information of the UE, whether to transmit, to the UE, the second signal for performing the beam measurement at a second beam level, comprises:
identifying a beam level related to the UE based on at least one of the information on transmission capacity, the mobility information or the traffic information of the UE; and
transmit, to the UE, the second signal for performing the beam measurement at the second beam level, based on the identified beam level related to the UE being the second beam level.

7. The method according to claim 6, further comprising:
identifying, based on at least one of the information on transmission capacity or the mobility information of the UE, an adjusted beam level related to the UE; and
identifying, based on the traffic of the UE to be transmitted, whether to adjust the beam level for the UE from the first beam level to the adjusted beam level.

8. The method according to claim 7, wherein, identifying whether to adjust the beam level for the UE from the first beam level to the adjusted beam level, comprises:
based on the traffic of the UE to be transmitted not being existed, adjusting the beam level for the UE from the first beam level to the adjusted beam level; and
based on the traffic of the UE to be transmitted being existed, maintaining the beam level for the UE as the first beam level and saving the adjusted beam level.

9. The method according to claim 6, further comprising:
identifying, based on at least one of the traffic of the UE to be transmitted within a specified number of consecutive slots, the information on transmission capacity or the mobility information of the UE, whether to adjust the beam level for the UE to the first beam level.

10. The method according to claim 9, wherein, identifying whether to adjust the beam level for the UE to the first beam level, comprises:
based on the traffic of the UE to be transmitted being existed within a specified number of consecutive slots, adjusting the beam level for the UE to the first beam level and saving the beam level for the UE before the adjustment;
based on the information on transmission capacity of the UE indicating that the transmission capacity of the UE meets a first specified condition, adjusting the beam level for the UE to the first beam level; and
based on the mobility information of the UE indicating that the mobility of the UE meets a second specified condition, adjusting the beam level for the UE to the first beam level.

11. The method according to claim 9, further comprising:
based on the traffic of the UE being generated from a state that the traffic is not existed, adjusting the beam level for the UE to the corresponding second beam level; and
wherein, the corresponding second beam level is the last saved beam level.

12. The method according to claim 6, wherein, based on the UE being operated in the second beam level, identifying the beam level corresponding to the UE, comprises:
identifying, based on at least one of the information on transmission capacity or the mobility information of the UE, whether to adjust the beam level for the UE to another second beam level.

13. The method according to claim 12, wherein, identifying whether to adjust the beam level for the UE to the another second beam level, comprises:
based on the information on transmission capacity of the UE indicating that the transmission capacity of the UE meets a third specified condition and the mobility information of the UE indicating that the mobility of the UE meets a fourth specified condition, adjusting the beam level for the UE to the another second beam level.

14. The method according to claim 1, further comprising:
obtaining, using a specified model, a predicted traffic of each beam coverage area of the first beam level, based on a historical traffic of each beam coverage area in the first beam level; and
identifying, based on the predicted traffic of each beam coverage area of the first beam level, the attribute information of the second beam according to the second beam level.

15. The method according to claim 14, further comprising:
obtaining historical information on transmission capacity of each beam at the first beam level; and
adjusting the predicted traffic of each beam coverage area of the first beam level based on the historical information on transmission capacity of each beam at the first beam level.

16. The method according to claim 14, further comprising:
identifying attribute information of beams including the first beam and the second beam,
wherein the attribute information of the beams comprises information on the number of the beams and information on beam widths of the beams,
wherein the information on the number of the beams comprises the number of vertical beams and the number of horizontal beams, and
wherein the information on beam widths of the beams comprises beam widths of the vertical beams and beam widths of the horizontal beams.

17. The method according to claim 16, further comprising:
obtaining, based on the number of vertical beams at the second beam level, the number of vertical beams at the first beam level, and a coverage width in a vertical dimension in a cell, information on vertical beam widths of the second beam level; and
obtaining, based on the number of horizontal beams at the second beam level, the number of horizontal beams at the first beam level, and a coverage width in a horizontal dimension in a cell, information on horizontal beam widths of the second beam level.

18. The method according to claim 1, further comprising:
after transmitting a signal to the UE through the first beam according to the first beam level at a first slot followed by a second slot, transmitting another signal to another UE through the second beam according to the second beam at the second slot,
wherein a beam width of the second beam is narrower than a beam width of the first beam.

19. A base station, comprising a memory and a processor;
wherein, the memory has computer programs stored therein; and
the processor is configured to execute the computer programs to:
transmit, to a user equipment (UE) a first signal for performing a beam measurement at a first beam level;
identify, based on at least one of information on transmission capacity, mobility information or traffic information of the UE received from the UE, whether to transmit, to the UE, a second signal for performing a beam measurement at a second beam level; and
receive, based on at least one of the first signal or the second signal, beam measurement results of the UE and performing beam scheduling,
wherein, a scheduled beam identified by the beam scheduling includes a beam at the first beam level or a beam at the second beam level,
wherein serving cells of the base station are covered by each of the beam levels, and
wherein attribute information of a first beam according to the first beam level is distinct from attribute information of a second beam according to the second beam level.

20. A non-transitory computer readable storage medium storing one or more programs, the one or more programs including instructions, which, when being executed by at least one processor of a base station cause the base station to:
transmit, to a user equipment (UE) a first signal for performing a beam measurement at a first beam level;
identify, based on at least one of information on transmission capacity, mobility information or traffic information of the UE received from the UE, whether to transmit, to the UE, a second signal for performing a beam measurement at a second beam level; and
receive, based on at least one of the first signal or the second signal, beam measurement results of the UE and performing beam scheduling,
wherein, a scheduled beam identified by the beam scheduling includes a beam at the first beam level or a beam at the second beam level,
wherein serving cells of the base station are covered by each of the beam levels, and
wherein attribute information of a first beam according to the first beam level is distinct from attribute information of a second beam according to the second beam level.
